(19) United States
(12) Patent Application Publication
(10) Pub. No.: US 2026/0303784 A1
(43) Pub. Date: Oct. 1, 2026

(54) IMAGE CODING METHOD AND APPARATUS THEREFOR BASED ON REFERENCE FRAME LIST

(71) Applicant: LX SEMICON CO., LTD., Daejeon (KR)

(72) Inventors: Jin Wook LEE, Daejeon (KR); Young Jun KIM, Daejeon (KR)

(73) Assignee: LX SEMICON CO., LTD., Daejeon (KR)

(21) Appl. No.: 19/578,443

(22) Filed: Mar. 25, 2026

(30) Foreign Application Priority Data
Mar. 26, 2025 (KR) 10-2025-0038996

(51) Int. Cl. H04N 19/105; H04N 19/172; H04N 19/196; H04N 19/577

(52) U.S. Cl. CPC H04N 19/105; H04N 19/172; H04N 19/196; H04N 19/577

(57) ABSTRACT

An image decoding method according to an embodiment of the disclosure includes deriving costs of reference frames of a current frame, constructing a reference frame list based on the costs, deriving motion information of a current block in the current frame, and deriving prediction samples of the current block based on the reference frame list and the motion information, wherein a cost of a reference frame of the current frame is derived based on a temporal distance and a quantization parameter of the reference frame.

### CROSS REFERENCE TO RELATED APPLICATION

The present application claims priority to Korean Patent Application No. 10-2025-0038996 filed on Mar. 26, 2025, the entire contents of which is incorporated herein for all purposes by this reference.

### BACKGROUND OF THE DISCLOSURE

### Field of the Disclosure

The disclosure relates to an image/video coding method and an image/video coding apparatus.

### Related Art

With an increasing use of multimedia data, the need for efficient video compression technology is rising. Video compression is essential for effectively transmitting high-quality image data within limited network bandwidth. To this end, various video codec technologies have been developed.

Video codec technologies include MPEG-2, H.264/AVC, H.265/HEVC, H.266/VVC, and AOMedia video 1 (AV1), which are expected to be widely utilized in diverse applications, such as Internet-based video streaming, video calls, virtual reality (VR), and augmented reality (AR).

As images/video reach high resolution and high quality, the data size of images/video expands, resulting in a relative increase in the amount of information or bits transmitted. Therefore, when transmitting image data using conventional media, such as wired and wireless broadband lines, or storing image/video data using existing storage media, costs for transmission and storage rise. To provide further improved compression efficiency image quality, there is a growing need for successor codec technologies, such as H.267 and AV2. In other words, high-efficiency image/video compression technology is required to effectively compress, transmit, store, and play high-resolution and high-quality image/video information.

### SUMMARY

According to an embodiment of the disclosure, there are provided a method and an apparatus for enhancing video/image coding efficiency.

According to an embodiment of the disclosure, there are provided a method and an apparatus for providing a next-generation high-quality video service.

According to an embodiment of the disclosure, there are provided a method and an apparatus for providing enhanced performance in a real-time streaming environment.

According to an embodiment of the disclosure, there are provided a video/image coding method and apparatus based on inter prediction.

According to an embodiment of the disclosure, there is provided an image decoding method performed by a decoding apparatus. The method includes deriving costs of reference frames of a current frame, constructing a reference frame list based on the costs, deriving motion information of a current block in the current frame, and deriving prediction samples of the current block based on the reference frame list and the motion information, wherein a cost of a reference frame of the current frame is derived based on a temporal distance and a quantization parameter of the reference frame.

According to an embodiment of the disclosure, there is provided an image encoding method performed by an encoding apparatus. The method includes deriving costs of reference frames of a current frame, constructing a reference frame list based on the costs, deriving motion information of a current block in the current frame, deriving prediction samples of the current block based on the reference frame list and the motion information, and encoding image information including prediction related information of the current block, wherein a cost of a reference frame of the current frame is derived based on a temporal distance and a quantization parameter of the reference frame.

According to an embodiment of the disclosure, there is provided a decoding apparatus for image decoding. The decoding apparatus includes a memory and at least one processor connected to the memory, wherein the at least one processor is configured to perform an operation of deriving costs of reference frames of a current frame, constructing a reference frame list based on the costs, deriving motion information of a current block in the current frame, and deriving prediction samples of the current block based on the reference frame list and the motion information, wherein a cost of a reference frame of the current frame is derived based on a temporal distance and a quantization parameter of the reference frame.

According to an embodiment of the disclosure, there is provided an encoding apparatus for image encoding. The encoding apparatus includes a memory and at least one processor connected to the memory, wherein the at least one processor is configured to perform an operation of deriving costs of reference frames of a current frame, constructing a reference frame list based on the costs, deriving motion information of a current block in the current frame, deriving prediction samples of the current block based on the reference frame list and the motion information, and encoding image information including prediction related information of the current block, wherein a cost of a reference frame of the current frame is derived based on a temporal distance and a quantization parameter of the reference frame.

According to an embodiment of the disclosure, there is provided a method for storing or transmitting video/video data including a bitstream generated by a video/image encoding method according to at least one of embodiments of the disclosure.

According to an embodiment of the disclosure, there is provided an apparatus for storing or transmitting video/video data including a bitstream generated by a video/image encoding method according to at least one of embodiments of the disclosure.

According to an embodiment of the disclosure, there is provided a computer-readable storage medium that stores a program for performing a method according to at least one of the embodiments of the disclosure.

According to an embodiment of the disclosure, there is provided a computer-readable digital storage medium that stores encoded video/image information generated by a video/image encoding method according to at least one of embodiments of the disclosure.

According to an embodiment of the disclosure, there is provided a computer-readable digital storage medium that stores encoded information or encoded video/image information that causes a decoding apparatus to perform a video/image decoding method according to at least one of the embodiments of the disclosure.

According to an embodiment of the disclosure, overall video/image compression efficiency may be enhanced.

According to an embodiment of the disclosure, prediction performance for a current block may be enhanced.

According to an embodiment of the disclosure, reference frame list based prediction efficiency of a current block may be enhanced.

### BRIEF DESCRIPTION OF THE DRAWINGS

FIG. 1 schematically illustrates an example of a video/image coding system to which embodiments of the disclosure are applicable.

FIG. 2 is a diagram schematically illustrating a configuration of a video/image encoding apparatus to which embodiments of the disclosure are applicable.

FIG. 3 is a diagram schematically illustrating a configuration of a video/image decoding apparatus to which embodiments of the disclosure are applicable.

FIG. 4 illustrates an inter prediction procedure.

FIG. 5 illustrates examples of inter prediction based video/image encoding methods.

FIG. 6 illustrates examples of inter prediction based video/image decoding methods.

FIG. 7 illustrates an example of a method of determining an inter prediction mode/type of a current block.

FIG. 8 illustrates an example of motion samples used to derive WARP parameters of a current block to which the LOCAL WARP mode is applied.

FIG. 9 illustrates an example of motion vectors of the current block to which the WARP EXTEND mode is applied.

FIG. 10 illustrates an embodiment of performing inter prediction based on a TIP reference frame of a current frame.

FIG. 11 illustrates an embodiment of deriving MVDs for reference frames based on a joint MVD.

FIG. 12 illustrates an embodiment of constructing a reference frame list based on costs.

FIG. 13 schematically illustrates a video/image encoding method according to an embodiment(s) of the disclosure.

FIG. 14 schematically illustrates a video/image decoding method according to an embodiment(s) of the disclosure.

### DESCRIPTION OF EXEMPLARY EMBODIMENTS

As the disclosure may have various changes and various embodiments, specific embodiments are illustrated in the drawings and will be described in detail. However, it should be understood that there is no intent to limit embodiments of the disclosure to the specific embodiments. The terminology used herein is for the purpose of describing particular embodiments only and is not intended to limit the technical spirit of the disclosure. As used in the disclosure, singular forms are intended to include plural forms unless the context clearly indicates otherwise. As used herein, the term “and/or” includes any one and all combinations of two or more of the associated listed items. As used herein, the term “include,” “include,” and “have” specify the presence of stated features, numbers, operations, elements, components, and/or combinations thereof, but do not preclude the presence or addition of one or more other features, numbers, operations, elements, components, and/or combinations thereof. In the disclosure, the use of the term “may” in connection with an example or embodiment (e.g., regarding what an example or embodiment may include or implement) signifies that there is at least one example or embodiment in which such a feature is included or implemented, but all examples are not limited thereto and the corresponding feature or configuration may be omitted.

Each component of the drawings described in the disclosure is shown independently for the convenience of explaining distinct characteristic functions, which does not imply that each component is implemented as separate hardware or separate software. For example, two or more of these components may be combined to form a single component, or a single component may be divided into a plurality of components. Embodiments in which components are integrated and/or separated are also included within the scope of the disclosure without departing from the essence of the disclosure.

In the disclosure, “A or B” may mean “only A,” “only B,” or “both A and B.” In other words, “A or B” may be interpreted as “A and/or B” in the disclosure. For example, “A, B, or C” in the disclosure may mean “only A,” “only B,” “only C,” or “any and all combinations of A, B and C.”

A slash (/) or a comma as used herein may mean “and/or.” For example, “A/B” may mean “A and/or B.” Accordingly, “A/B” may mean “only A,” “only B,” or “both A and B.” For example, “A, B, C” may mean “A, B, or C.”

In the disclosure, “at least one of A and B” may mean “only A,” “only B,” or “both A and B.” Further, the expression “at least one of A or B” or “at least one of A and/or B” may be interpreted identically to “at least one of A and B.”

In the disclosure, “at least one of A, B and C” may mean “only A,” “only B,” “only C,” or “any and all combinations of A, B and C.” In addition, “at least one of A, B or C” or “at least one of A, B and/or C” may mean “at least one of A, B and C.”

Parentheses used in the disclosure may mean “for example.” Specifically, when indicated as “prediction (intra prediction),” “intra prediction” may be proposed as an example of “prediction.” In other words, “prediction” in the disclosure is not limited to “intra prediction,” and “intra prediction” may be proposed as an example of “prediction.” Furthermore, even when indicated as “prediction (i.e., intra prediction),” “intra prediction” may be proposed as an example of “prediction.”

In the disclosure, technical features individually explained within a single drawing may be implemented independently, or may be implemented simultaneously.

The disclosure relates to video/image coding. For example, a method/embodiment described in the disclosure may be applied to a method disclosed in an AOMedia Video 2 (AV2) standard. In addition, the method/embodiment disclosed herein may be applied to a method disclosed in an enhanced compression model, an H.267 standard, or a next-generation video/image coding standard (e.g., H.268 and H.269).

In the disclosure, coding may include encoding and/or decoding. In the disclosure, image coding may be used interchangeable with video coding.

In the disclosure, a video may refer to a set of a series of images over time. A frame generally refers to a unit representing a single image at a specific time, and a slice/tile refers to a unit forming a portion of a frame in coding. A slice/tile may include one or more superblock. A single frame may include one or more slices/tiles. A tile may represent a rectangular area of superblocks within a specific tile row and a specific tile column in a frame. A single frame may be divided into two or more subframes.

A pixel or a pel may mean a smallest unit forming one frame (or image). “Sample” may be used as a term corresponding to a pixel. A sample may generally represent a pixel or a pixel value, and may represent only a pixel/pixel value of a luma component or only a pixel/pixel value of a chroma component.

A unit may represent a basic unit of image processing. A unit may include at least one of a specific area of a frame and information related to the area. A single unit may include one luma block and two chroma (e.g., Cb and cr) blocks. A unit may be used interchangeably with terms such as a “block” or an “area” in some cases. In general, an M×N block may include a set (or array) of samples (or a sample array) or transform coefficients in M columns and N rows.

Hereinafter, embodiments of the disclosure will be described in detail with reference to the accompanying drawings. In addition, like reference numerals may be used to indicate like elements throughout the drawings, and redundant descriptions of the like elements may be omitted.

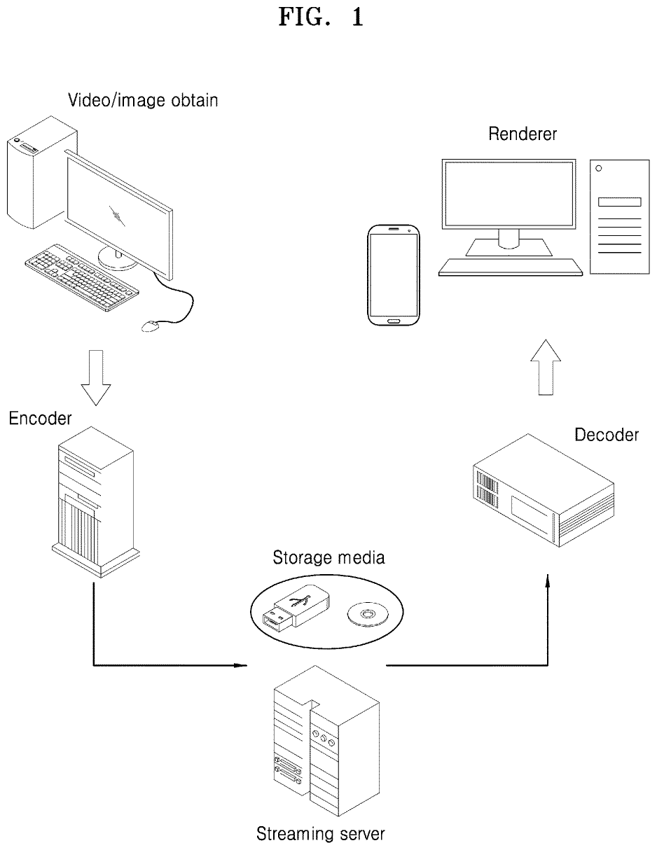

FIG. 1 schematically illustrates an example of a video/image coding system to which embodiments of the disclosure are applicable.

Referring to FIG. 1, the video/image coding system may include a first apparatus (encoding apparatus) and a second apparatus (decoding apparatus). The first apparatus may deliver encoded video/image information or data in a form of a file or streaming to the second apparatus via a digital storage medium or a network.

The video/image coding system may further include a video/image acquisition device and a video/image renderer. The video/image acquisition device may be included in the encoding apparatus, or may be configured as a separate device or an external component. The video/image renderer may be included in the decoding apparatus, or may be configured as a separate device or an external component.

The first apparatus may include a transmitter as an internal component, or as a separate device or an external component.

The second apparatus may include a receiver as an internal component, or as a separate device or an external component.

The encoding apparatus may be referred to as an encoder, and the decoding apparatus may be referred to as a decoder. The transmitter may be included in the encoding apparatus. The receiver may be included in the decoding apparatus. The renderer may include a display, and the display may be configured as a separate device or an external component.

The decoding apparatus and the encoding apparatus to which an embodiment(s) of the disclosure is applied may be included in a multimedia broadcasting transmission/reception device, a mobile communication terminal, a home cinema video device, a digital cinema video device, a surveillance camera, a video conversation device, a real-time communication device such as video communication, a mobile streaming device, a storage medium, a camcorder, a video-on-demand (VOD) service providing device, an over-the-top (OTT) video device, an Internet streaming service providing device, a three-dimensional (3D) video device, a virtual reality (VR) device, an augmented reality (AR) device, a video telephony device, a transportation terminal (e.g., a vehicle terminal (including an autonomous vehicle terminal), an aircraft terminal, and a vessel terminal), and a medical video device, and may be used to process a video signal or a data signal. For example, the over-the-top (OTT) video device may include a game console, a Blu-ray player, an Internet-connected TV, a home theater system, a smartphone, a tablet PC, and a digital video recorder (DVR).

The video/image acquisition device may obtain a video/image source. The video/image acquisition device may obtain a video/image through a process of capturing, synthesizing, or generating a video/image. The video/image acquisition device may include a video/image capture device and/or a video/image generation device. The video/image capture device may include, for example, one or more cameras and a video/image archive including previously captured video/images. The video/image generation device may include, for example, a camcorder, a computer, a tablet PC, and a smartphone, and may (electronically) generate a video/image. For example, a virtual video/image may be generated through a computer, in which case a video/image capture process may be replaced with a process of generating related data. The video/image source may perform a video/image preprocessing process to input an optimized video/image to the encoder.

The encoding apparatus may encode an input video/image. The encoding apparatus may encode an input video/image through an encoding method disclosed herein. The encoding apparatus may perform a series of procedures, such as prediction, transform, and quantization, for compression and coding efficiency. Encoded data (encoded video/image information) may be output in a form of a bitstream.

The transmitter may transmit encoded image/image information or data output in a form of a bitstream to the receiver of the receiving device in a form of a file or streaming through the digital storage medium or the network. The encoded image/image information or data output in the form of the bitstream may be transmitted to the receiver through a streaming server. The digital storage medium may include various storage mediums, such as a USB, an SD, a CD, a DVD, a Blu-ray, an HDD, and an SSD. The transmitter may include an element for generating a media file through a predetermined file format, and may include an element for transmission through a broadcast/communication network. The receiver may receive/extract the bitstream and transmit the received bitstream to the decoding apparatus. In the disclosure, the transmitter may be referred to as a transmitting apparatus, and the receiver may be referred to as a receiving apparatus. As image/video resolution and quality become higher, the raw data size of images/videos is increasing. By obtaining and storing/transmitting a bitstream (or data including the bitstream) generated by an efficient encoding method according to the disclosure, it is possible to increase storage/transmission efficiency and support low-latency/real-time transmission.

The streaming server may temporarily store the bitstream during a process of transmitting or receiving the bitstream. The streaming server transmits multimedia data to a user device, based on a user request via a web server, and the web server serves as an intermediary for informing a user of an available service. When the user requests a desired service from the web server, the web server transmits the request to the streaming server, and the streaming server transmits multimedia data to the user. The content streaming system may include a separate control server, in which case the control server controls a command/response between devices in the content streaming system.

The streaming server may receive content from a media storage and/or the encoding apparatus. For example, when receiving content from the encoding apparatus, the content may be received in real time. In this case, the streaming server may store the bitstream for a certain time to provide a smooth streaming service.

The decoding apparatus may decode the video/image by performing a series of procedures, such as dequantization, inverse transform, and prediction, corresponding to an operation of the encoding apparatus. The decoding apparatus may decode a video/image through a decoding method disclosed herein.

The renderer may render the decoded video/image. The rendered video/image may be displayed on the display.

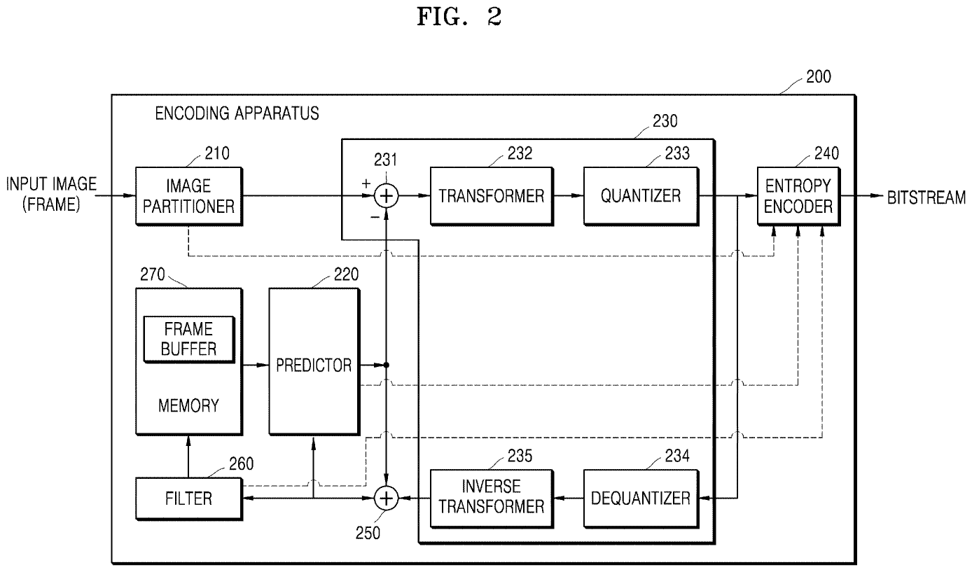

FIG. 2 is a diagram schematically illustrating a configuration of a video/image encoding apparatus to which embodiments of the disclosure are applicable. Hereinafter, an encoding apparatus may include an image encoding apparatus and/or a video encoding apparatus.

Referring to FIG. 2, the encoding apparatus 200 may include an image partitioner 210, a predictor 220, a residual processor 230, and an entropy encoder 240, an adder 250, a filter 260, and a memory 270. The predictor 220 may include an inter predictor and an intra predictor. The residual processor 230 may include a transformer 232, a quantizer 233, a dequantizer 234, and an inverse transformer 235. The residual processor 230 may further include a subtractor 231. The adder 250 may be referred to as a reconstructor or a reconstructed block generator. The image partitioner 210, the predictor 220, the residual processor 230, the entropy encoder 240, the adder 250, and the filter 260 may be configured as at least one hardware component (e.g., an encoder chipset or processor) according to an embodiment. The memory 270 may include a frame buffer, or may be configured as a digital storage medium. The hardware component may further include the memory 270 as an internal/external component.

The image partitioner 210 may partition an input image (or a picture or a frame) input to the encoding apparatus 200 into one or more processing unit. For example, the processing unit may include a superblock or a coding unit (CU). A frame may be partitioned into a plurality tiles. A tile may have a rectangular shape. Uniform or non-uniform tile sizes may be determined on a per-frame basis. In the disclosure, the terms “frame” and “picture” may be used interchangeably. A tile may include an integer number of superblocks. Superblocks within a tile may be coded in raster scan order. A superblock may be partitioned into one or more coding blocks. For example, a superblock may have a size of 128×128 or 64×64 based on a luma component. Alternatively, a superblock may have a size of 256×256 based on the luma component. A superblock may have a dependency only on specific neighboring superblocks. For example, a superblock may have a dependency only on left and/or upper neighboring superblocks.

A superblock may be recursively partitioned. For example, a superblock may be derived as a single coding block, or a superblock may be partitioned into coding blocks, based on a binary tree, a ternary tree, or a quad tree. One coding block may be recursively partitioned into a plurality of coding blocks of a deeper depth, based on a binary tree, a ternary tree, or a quad tree. For example, when a coding block is partitioned into PARTITION_N×N, recursive partitioning may be possible. A coding procedure according to the disclosure may be performed based on a final coding block that is no longer partitioned. In this case, a superblock may be directly used as the final coding block, based on coding efficiency according to video characteristics. Alternatively, a coding block may be recursively partitioned into deeper-depth coding blocks as needed so that a coding block with an optimal size may be used as the final coding block. Here, the coding procedure may include procedures such as prediction, transform, and reconstruction, which will be described later. The processing unit may further include a prediction block (PB) or a transform block (TB). In this case, the prediction block or the transform block may be split or partitioned from the final coding block described above. For example, a single transform block of the same size as the coding block may be derived, or a plurality of transform blocks may be derived from the coding block, based on a quad tree or binary tree. The transform block may be recursively partitioned into deeper-depth transform blocks. The prediction block may be a unit for prediction (or for deriving a prediction mode), and the transform block may be a unit for performing a transform, a unit for deriving a transform coefficient, and/or a unit for deriving a residual signal from a transform coefficient. For example, prediction mode derivation for intra prediction may be performed on a coding block basis or a prediction block basis, and prediction sample derivation through an intra prediction procedure may be performed on a transform block basis. A block to be currently processed according to a coding order may be referred to as a current block.

The term “block” may be used interchangeably with the term “unit” or “area” depending on a case. In general, an M×N block may denote an array of samples or transform coefficients arranged in M rows and N columns. A sample may generally denote a pixel or a pixel value, and may represent only a pixel/pixel value of a luma component or only a pixel/pixel value of a chroma component. A “sample” may be used as a term corresponding to a pixel or pel of a frame (or image).

The encoding apparatus 200 may generate a residual signal (residual signal, residual block, or residual sample array) by subtracting a prediction signal (predicted block or predicted sample array) output from the predictor from an input image signal (original block or original sample array), and the generated residual signal is transmitted to the transformer 232. In this case, as illustrated, a component for subtracting the prediction signal (predicted block or predicted sample array) from the input image signal (original block or original sample array) in the encoder 200 may be referred to as the subtractor 231. The predictor may perform prediction on a processing target block (hereinafter, referred to as a current block), and may generate a predicted block including prediction samples for the current block. The predictor may determine whether intra prediction or inter prediction is applied on a current block or coding block basis. The predictor may generate various pieces of information about prediction, such as prediction mode information, and may transmit the generated information to the entropy encoder 240, as described below in a description of each prediction mode. The information about prediction may be encoded by the entropy encoder 240 and output in a form of a bitstream.

The intra predictor may predict the current block with reference to samples within a current frame. The referenced samples may be located adjacent to (neighboring) the current block, or may be located away from the current block depending on a prediction mode. Intra prediction may be performed on a transform block basis. When a plurality of transform blocks exists in a coding block, intra prediction may be performed sequentially in a raster order of the transform blocks. In this case, a procedure for deriving neighboring reference samples for intra prediction may be performed based on a transform block. A plurality of prediction modes may be considered for intra prediction. The prediction modes may include a plurality of non-directional modes and a plurality of directional modes. A prediction mode used for the current block may be signaled from the encoding apparatus to a decoding apparatus, and the prediction modes may include, for example, a DC intra prediction mode, a plurality of directional intra prediction modes, a plurality of SMOOTH intra prediction modes, and/or a PAETH intra prediction mode. The prediction modes may include an intra block copy (intrabc) mode. Whether the intra block copy mode is applied may be signaled separately. The directional prediction modes may include, for example, eight or more prediction modes depending on a prediction direction, which is, however, only for illustration, and a greater or smaller number of directional prediction modes may be used depending on a configuration. The intra predictor may also determine a prediction mode to be applied to the current block, based on a prediction mode applied to a neighboring block. In the intra block copy mode, similar to an inter prediction mode described below, a reference block is derived based on a vector, and the current frame is used as a reference frame. The vector used to derive the reference block in the intra block copy mode may be referred to as a block vector.

The inter predictor may induce a predicted block for the current block, based on a reference block (reference sample array) specified by a motion vector on a reference picture. Here, to reduce the amount of motion information transmitted in the inter prediction mode, motion information may be predicted on a block, sub-block, or sample basis, based on a correlation in motion information between a neighboring block and the current block. The motion information may include a motion vector and/or a reference frame index. The motion information may further include inter prediction direction (L0 prediction, L1 prediction, and compound prediction) information. In inter prediction, the neighboring block may include a spatial neighboring block existing within a current frame and a temporal neighboring block existing in the reference frame. A reference frame including the reference block and the reference frame including the temporal neighboring block may be the same or different. The temporal neighboring block may be referred to as a co-located reference block or a co-located block (colblock), and the reference frame including the temporal neighboring block may also be referred to as a co-located frame (colframe). For example, the inter predictor may configure a motion information stack, based on neighboring blocks, and may generate information indicating a candidate used to derive the motion vector and/or the reference frame index of the current block. The motion information stack may be referred to as a motion information list. The motion information stack may include a motion vector stack. The motion vector stack may be referred to as RefStackMv. The motion vector stack may include eight or more candidates. Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode and/or a local warp mode. The OBMC mode may improve prediction performance by using motion information about a neighboring block at a left and/or upper boundary of the current block, and the local warp mode may apply an affine model in addition to translational motion compensation.

A motion vector may be derived based on various prediction modes. For example, in an NEWMV mode, a motion vector of the current block may be indicated based on a motion vector of a reference stack and a motion vector difference. If needed, in the NEWMV mode, the motion vector of the current block may be indicated based on the motion vector difference without the motion vector of the reference stack. Information about the motion vector difference may be generated by the encoding apparatus and signaled to the decoding apparatus. A ZEROMV mode may indicate that a zero vector or a default vector is used as the motion vector of the current block. An REFMV mode may indicate that a motion vector of the motion information stack is used as the motion vector of the current block. However, these designations are only examples, and the motion vector of the current block may be indicated by various other names. For example, a GLOBALMV mode may indicate that global motion information is used for the current block. For example, an NEARSTMV mode may indicate that a first candidate (candidate at index 0) of the motion information stack is used for the current block. For example, an NEARMV mode may indicate that a specific candidate (indicated by refMVidx) of the motion information stack is used for the current block. However, the above mode names are examples, and other names, such as mode 1 and mode 2, may be used if needed.

When compound prediction is applied, inter prediction may be performed using both reference frame lists L0 and L1. In this case, a motion vector for an L0 direction and a motion vector for an L1 direction may be derived. Furthermore, an L0 reference frame for the L0 direction and an L1 reference frame for the L1 direction may be derived. If needed, a first motion vector and a second motion vector may be used instead of an L0 motion vector and an L1 motion vector, respectively. If needed, a first reference frame and a second reference frame may be used instead of the L0 reference frame and the L1 reference frame, respectively.

The predictor 220 may generate a prediction signal, based on various prediction methods. For example, the predictor may apply intra prediction or inter prediction for prediction of one block, and may simultaneously apply intra prediction and inter prediction, which may be referred to as compound inter-intra prediction. In this case, a mode used for the intra prediction may include the DC prediction mode, a vertical prediction mode, a horizontal prediction mode, and the SMOOTH prediction mode. Further, the predictor may be based on the intra block copy mode described above or a palette mode for the prediction of the block. As described above, the intra block copy mode is a type of intra prediction and basically performs prediction within the current frame, but may be performed similarly to inter prediction in that the mode derives a reference block, based on a vector using the current frame as a reference frame. However, since the current frame is used as the reference frame, the term “block vector” may be used for a vector for displacement instead of “motion vector”. That is, the intra block copy mode may utilize at least one of inter prediction techniques described in the disclosure. In this case, a motion vector derived through a neighboring block or the motion information stack may be referenced for deriving a block vector of the current block. For example, when the intra block copy mode is applied, the foregoing NEWMV mode may be used for deriving the block vector of the current block.

The prediction signal generated by the predictor 220 may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a Karhunen-Loeve transform (KLT), a graph-based transform (GBT), or a conditionally non-linear transform (CNT). Further, the transform technique may include, for example, a DCT, asymmetric discrete sine transform (ADST), a flipped ADST (FLIPADST), an identity transform (IDTX), a Walsh-Hadamard transform (WHT), a V_DCT, and an H_DCT. The DCT is one of the most widely used transformation techniques in image compression, primarily transforming image signals into a frequency domain to concentrate energy into low-frequency components. The ADST is similar to the DCT, but is designed to smoothly connect signals at block boundaries. The FLIPADST is a modified version of the ADST that applies a transform in a reversed direction, enabling more efficient signal compression for a specific block pattern. The IDTX is an identity transformation method that maintains a signal without any transformation. The identity transform may be applied to either a vertical transform or a horizontal transform, or both. For example, when a transformation method is specified for only one of the vertical and horizontal transforms, the identity transform may be implicitly applied to the other transform. The WHT is a linear transform similar to a discrete Fourier transform (DFT) or discrete cosine transform (DCT), representing signals or data by transforming the same into a different basis. The WHT may use an orthogonal basis matrix including +1 and −1 instead of using a trigonometric function (sine and cosine). The V_DCT and the H_DCT indicate that the DCT transform is performed in the vertical direction of a block and the DCT transform is performed in the horizontal direction of the block, respectively. For example, for a simple block, the DCT may be used to increase a compression ratio, while the ADST or FLIPADST may be used when smooth transitions are required at boundaries. For a block where a signal remains nearly unchanged, the IDTX may be applied.

The quantizer 233 may quantize the transform coefficients and transmit the same to the entropy encoder 240, and the entropy encoder 240 may encode a quantized signal (information about the quantized transform coefficients) and output the encoded signal as a bitstream. The information about the quantized transform coefficients may be referred to as residual information. The quantizer 233 may rearrange the quantized transform coefficients in a block form into a one-dimensional vector form, based on a coefficient scan order, and may generate the information about the transform coefficients, based on the quantized transform coefficients in the one-dimensional vector form. The entropy encoder 240 may perform various encoding methods, for example, a cumulative distribution function and context-adaptive binary arithmetic coding (CABAC). The CDF is a method of storing cumulative values of a probability distribution, allowing symbols to be represented with fewer bits compared to storing probabilities directly. Within the CDF, symbol probabilities may be adaptively adjusted based on context. The entropy encoder 240 may encode information (e.g., values of syntax elements) necessary for video/image reconstruction other than the quantized transform coefficients together or separately. The encoded information (e.g., encoded video/image information) may be packetized on an open bitstream unit (OBU) basis in a form of a bitstream and be transmitted or stored. The video/image information may further include information commonly applied to a specific range, such as a tile header, a frame header, and a sequence header. In the disclosure, information and/or syntax elements transmitted/signaled from the encoding apparatus to the decoding apparatus may be included in the video/image information. The video/image information may be encoded through the foregoing encoding procedure and included in the bitstream. The bitstream may be transmitted through a network, or may be stored in a digital storage medium. The network may include a broadcasting network and/or a communication network, and the digital storage medium may include various storage media, such as a USB, an SD, a CD, a DVD, a Blu-ray, an HDD, and an SSD. A transmitter (not shown) and/or a storage (not shown) for transmitting and/or storing a signal output from the entropy encoder 240 may be configured as internal/external elements of the encoding apparatus 200, or the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transform unit 235. The adder 250 may add the reconstructed residual signal to the prediction signal output from the predictor to generate a reconstructed signal (reconstructed frame, reconstructed block, or reconstructed sample array). When there is no residual for the processing target block, such as when a skip mode is applied, the predicted block may be used as a reconstructed block. The adder 250 may be referred to as a reconstructor unit or a reconstructed block generator. The generated reconstructed signal may be used for intra prediction of a next processing target block in the current frame, or may be used for inter prediction of a next frame after being filtered as described below.

The filter 260 may improve subjective/objective image quality by applying filtering to the reconstructed signal. For example, the filter 260 may generate a modified reconstructed frame by applying various filtering methods to the reconstructed frame, and may store the modified reconstructed frame in the memory 270, specifically, in the frame buffer of the memory 270. The various filtering methods may include, for example, deblocking filtering, a sample adaptive offset, an adaptive loop filter, and a bilateral filter. The filter 260 may generate information related to the filtering, and may transmit the generated information to the entropy encoder 240. The information related to the filtering may be encoded by the entropy encoder 240 and output in a form of a bitstream.

The modified reconstructed frame transmitted to the memory 270 may be used as a reference frame in the inter predictor. When inter prediction is applied via the modified reconstructed frame, the encoding apparatus may avoid a prediction mismatch between the encoding apparatus 200 and the decoding apparatus, and may improve encoding efficiency may be improved.

The memory 270 may store the modified reconstructed frame for use as the reference frame in the inter predictor. The memory 270 may store motion information about a block from which motion information in the current frame is derived (or encoded) and/or motion information about blocks in a frame already reconstructed. The stored motion information may be transmitted to the inter predictor to be utilized as motion information about the spatial neighboring block or motion information about the temporal neighboring block. The memory 270 may store reconstructed samples of reconstructed blocks in the current frame, and may transmit the reconstructed samples to the intra predictor.

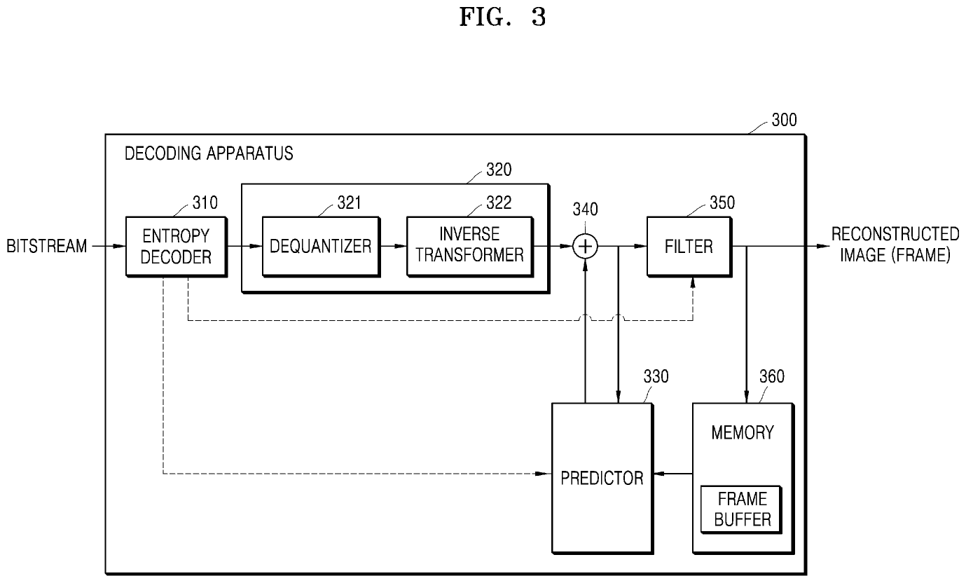

FIG. 3 is a diagram schematically illustrating a configuration of a video/image decoding apparatus to which embodiments of the disclosure are applicable. Hereinafter, a decoding apparatus may include an image decoding apparatus and/or a video decoding apparatus.

Referring to FIG. 3, the decoding apparatus 300 may include an entropy decoder 310, a residual processor 320, a predictor 330, an adder 340, a filter 350, and a memory 360. The predictor 330 may include an inter predictor and an intra predictor. The residual processor 320 may include a dequantizer 321 and an inverse transformer 322. The entropy decoder 310, the residual processor 320, the predictor 330, the adder 340, and the filter 350 may be configured as a single hardware component (e.g., a decoder chipset or processor) according to an embodiment. The memory 360 may include a frame buffer, and may be configured as a digital storage medium. The hardware component may further include the memory 360 as an internal/external component.

When a bitstream including video/image information is input, the decoding apparatus 300 may reconstruct an image according to a process in which the video/image information is processed in the encoding apparatus of FIG. 2. For example, the decoding apparatus 300 may derive units/blocks, based on block partition-related information obtained from the bitstream. The decoding apparatus 300 may perform decoding using a processing unit applied to the encoding apparatus. Therefore, the processing unit for decoding may be, for example, a superblock or a coding unit, and a coding unit may be partitioned from a superblock according to a quad-tree structure, a binary-tree structure, and/or a ternary-tree structure. One or more prediction blocks or transform units may be derived from a coding unit. A reconstructed image signal decoded and output by the decoding apparatus 300 may be reproduced via a reproducing apparatus.

The decoding apparatus 300 may receive a signal output from the encoding apparatus in a form of a bitstream, and the received signal may be decoded by the entropy decoder 310. For example, the entropy decoder 310 may parse the bitstream to derive information (e.g., video/image information) necessary for image reconstruction (or frame reconstruction). The video/image information may further include information commonly applied to a specific range, such as a tile header, a frame header, and a sequence header. The decoding apparatus may decode a frame, based on the header information. In the disclosure, signaled/received information and/or syntax elements to be described below may be decoded through the decoding procedure and may be obtained from the bitstream. For example, the entropy decoder 310 may decode the information in the bitstream, based on a coding method, such as a CDF and CABAC, and may output a value of a syntax element required for image reconstruction and a quantized value of a transform coefficient for a residual. More specifically, the CDF-based coding method may include a procedure of storing a probability distribution of symbols in a form of a CDF, selecting an appropriate CDF by analyzing context of a current block, encoding symbols at an encoder side, based on the CDF, and reconstructing syntax elements/information using the same CDF at a decoder side. The CABAC method may determine a context model by using a target syntax element/information and coding information about neighboring and coding target blocks or information about a symbol/bin coded in a previous stage, generate a bit string by predicting an occurrence probability of a bin according to the determined context model and performing arithmetic encoding on the bin at the encoder side, and generate a symbol corresponding to a value of each syntax element by predicting an occurrence probability of a bin according to the determined context model and performing arithmetic decoding on the bin at the decoder side. Here, after determining the context model, the context model may be updated using information about a coded symbol/bin for a context model of a next symbol/bin. Prediction-related information among the information decoded by the entropy decoder 310 may be provided to the predictor 330, and a residual value obtained through entropy decoding in the entropy decoder 310, that is, quantized transform coefficients and related parameter information, may be input to the residual processor 320. The residual processor 320 may derive a residual signal (residual block, residual samples, or residual sample array). Filtering-related information among the information decoded by the entropy decoder 310 may be provided to the filter 350. A receiver (not shown) for receiving a signal output from the encoding apparatus may be further configured as an internal/external element of the decoding apparatus 300, or the receiver may be a component of the entropy decoder 310. The decoding apparatus according to the disclosure may be referred to as a video/image/frame decoding apparatus, and may be divided into an information decoder (video/image/frame information decoder) and a sample decoder (video/image/frame sample decoder). The information decoder may include the entropy decoder 310, and the sample decoder may include at least one of the dequantizer 321, the inverse transformer 322, the adder 340, the filter 350, the memory 360, and the predictor 330. The dequantizer 321 may dequantize the quantized transform coefficients to output transform coefficients. The dequantizer 321 may rearrange the quantized transform coefficients in a two-dimensional block form. In this case, the rearrangement may be performed based on a coefficient scan order executed in the encoding apparatus. The dequantizer 321 may perform dequantization on the quantized transform coefficients using a quantization parameter (e.g., quantization step size information), and obtain the transform coefficients.

The inverse transformer 322 inversely transforms the transform coefficients to acquire a residual signal (residual block or residual sample array).

The predictor may perform prediction of the current block, and may generate a predicted block including prediction samples of the current block. The predictor may determine whether intra prediction is applied or inter prediction is applied to the current block, based on the prediction-related information output from the entropy decoder 310, and determine a specific intra/inter prediction mode.

The predictor 330 may generate a prediction signal, based on various prediction methods. For example, the predictor may apply intra prediction or inter prediction for prediction of one block, and may simultaneously apply intra prediction and inter prediction, which may be referred to as compound inter-intra prediction. In this case, a mode used for the intra prediction may include the DC prediction mode, a vertical prediction mode, a horizontal prediction mode, and the SMOOTH prediction mode. Further, the predictor may be based on the intra block copy mode described above or a palette mode for the prediction of the block. As described above, the intra block copy mode is a type of intra prediction and basically performs prediction within a current frame, but may be performed similarly to inter prediction in that the mode derives a reference block, based on a vector using the current frame as a reference frame. However, since the current frame is used as the reference frame, the term “block vector” may be used for a vector for displacement instead of “motion vector”. That is, the intra block copy mode may utilize at least one of inter prediction techniques described in the disclosure. In this case, a motion vector derived through a neighboring block or the motion information stack may be referenced for deriving a block vector of the current block. For example, when the intra block copy mode is applied, the foregoing NEWMV mode may be used for deriving the block vector of the current block.

The intra predictor may predict the current block with reference to samples within a current frame. The referenced samples may be located adjacent to (neighboring) the current block, or may be located away from the current block depending on a prediction mode. Intra prediction may be performed on a transform block basis. When a plurality of transform blocks exists in a coding block, intra prediction may be performed sequentially in a raster order of the transform blocks. In this case, a procedure for deriving neighboring reference samples for intra prediction may be performed based on a transform block. A plurality of prediction modes may be considered for intra prediction. The prediction modes may include a plurality of non-directional modes and a plurality of directional modes. A prediction mode used for the current block may be signaled from the encoding apparatus to a decoding apparatus, and the prediction modes may include, for example, a DC intra prediction mode, a plurality of directional intra prediction modes, a plurality of SMOOTH intra prediction modes, and/or a PAETH intra prediction mode. The prediction modes may include an intra block copy (intrabc) mode. Whether the intra block copy mode is applied may be signaled separately. The directional prediction modes may include, for example, eight or more prediction modes depending on a prediction direction, which is, however, only for illustration, and a greater or smaller number of directional prediction modes may be used depending on a configuration. The intra predictor may also determine a prediction mode to be applied to the current block, based on a prediction mode applied to a neighboring block. In the intra block copy mode, similar to an inter prediction mode described below, a reference block is derived based on a vector, and the current frame is used as a reference frame. The vector used to derive the reference block in the intra block copy mode may be referred to as a block vector. Intra prediction may be performed based on various prediction modes, and the prediction-related information obtainable through the bitstream may include information indicating an intra prediction mode for the current block.

The inter predictor may induce a predicted block for the current block, based on a reference block (reference sample array) specified by a motion vector on a reference picture. Here, to reduce the amount of motion information transmitted in the inter prediction mode, motion information may be predicted on a block, sub-block, or sample basis, based on a correlation in motion information between a neighboring block and the current block. The motion information may include a motion vector and/or a reference frame index. The motion information may further include inter prediction direction (L0 prediction, L1 prediction, and compound prediction) information. In inter prediction, the neighboring block may include a spatial neighboring block existing within a current frame and a temporal neighboring block existing in the reference frame. A reference frame including the reference block and the reference frame including the temporal neighboring block may be the same or different. The temporal neighboring block may be referred to as a co-located reference block or a co-located block, and the reference frame including the temporal neighboring block may also be referred to as a co-located frame. For example, the inter predictor may configure a motion information stack, based on neighboring blocks, and may generate information indicating a candidate used to derive the motion vector and/or the reference frame index of the current block. The motion information stack may be referred to as a motion information list. The motion information stack may include a motion vector stack. The motion vector stack may be referred to as RefStackMv. The motion vector stack may include eight or more candidates. Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode and/or a local warp mode. The OBMC mode may improve prediction performance by using motion information about a neighboring block at a left and/or upper boundary of the current block, and the local warp mode may apply an affine model in addition to translational motion compensation. Inter prediction may be performed based on various prediction modes, and the prediction-related information obtainable through the bitstream may include information indicating an inter prediction mode for the current block. For example, the inter predictor may configure a motion information stack, based on neighboring blocks, and may derive a motion vector and/or a reference frame index of the current block, based on received candidate selection information (e.g., a reference motion vector index and/or a reference frame index).

The adder 340 may add the obtained residual signal to the prediction signal (predicted block or prediction same array) output from the predictor 330 to generate a reconstructed signal (reconstructed frame, reconstructed block, or reconstructed sample array). When there is no residual for the processing target block, such as when a skip mode is applied, the predicted block may be used as a reconstructed block.

The adder 340 may be referred to as a reconstructor unit or a reconstructed block generator. The generated reconstructed signal may be used for intra prediction of a next processing target block in the current frame, or may be output or used for inter prediction of a next frame after being filtered as described below.

The filter 350 may improve subjective/objective image quality by applying filtering to the reconstructed signal. For example, the filter 350 may generate a modified reconstructed frame by applying various filtering methods to the reconstructed frame, and may transmit the modified reconstructed frame to the memory 360, specifically, to the frame buffer of the memory 360. The various filtering methods may include, for example, deblocking filtering, a sample adaptive offset, an adaptive loop filter, and a bilateral filter.

The (modified) reconstructed frame stored in the memory 360 may be used as a reference frame in the inter predictor. The memory 360 may store motion information about a block from which motion information in the current frame is derived (or decoded) and/or motion information about blocks in a frame already reconstructed. The stored motion information may be transmitted to the inter predictor to be utilized as motion information about the spatial neighboring block or motion information about the temporal neighboring block. The memory 360 may store reconstructed samples of reconstructed blocks in the current frame, and may transmit the reconstructed samples to the intra predictor.

In this specification, the embodiments described for each component of the encoding apparatus 200 may also be applied equally or correspondingly to the corresponding components of the decoding apparatus 300.

As described above, in performing video coding, prediction is conducted to increase compression efficiency. Through the prediction, a predicted block including prediction samples for a current block, which is a coding target block, may be generated. The predicted block includes the prediction samples in a spatial domain (or pixel domain). The predicted block is derived identically in an encoding apparatus and a decoding apparatus, and the encoding apparatus may enhance image coding efficiency by signaling information about a residual between an original block and the predicted block (residual information), rather than an original sample value of the original block, to the decoding apparatus. The decoding apparatus may derive a residual block including residual samples, based on the residual information, may generate a reconstructed block including reconstructed samples by combining the residual block and the predicted block, and may generate a reconstructed frame including the reconstructed blocks.

The residual information may be generated through transform and quantization procedures. For example, the encoding apparatus may derive a residual block between the original block and the predicted block, may perform a transform procedure on residual samples (a residual sample array) included in the residual block to derive transform coefficients, and may perform a quantization procedure on the transform coefficients to derive quantized transform coefficients, and may signal the related residual information to the decoding apparatus (via a bitstream). The residual information may include information, such as value information and position information about the quantized transform coefficients, a transform technique, a transform kernel, and a quantization parameter. The decoding apparatus may perform a dequantization/inverse transform procedure based on the residual information to derive the residual samples (or residual block). The decoding apparatus may generate a reconstructed frame, based on the predicted block and the residual block. The encoding apparatus may perform a dequantization/inverse transform on the quantized transform coefficients to derive the residual block for reference in inter prediction of a subsequent frame, and may generate a reconstructed frame, based on the residual block.

In the disclosure, at least one of quantization/dequantization and/or transform/inverse transform may be omitted. When the quantization/dequantization is omitted, the quantized transform coefficients may be referred to as transform coefficients. When the transform/inverse transform is omitted, the transform coefficients may be referred to as coefficients or residual coefficients, or may still be referred to as transform coefficients for consistency in expression.

Further, in the disclosure, a quantized transform coefficient and a transform coefficient may be referred to as a transform coefficient and a scaled transform coefficient, respectively. In this case, residual information may include information about a transform coefficient(s), and the information about the transform coefficient(s) may be signaled via residual coding syntax. Transform coefficients may be derived based on the residual information (or information about the transform coefficient(s)), and scaled transform coefficients may be derived through inverse transform (scaling) of the transform coefficients. Residual samples may be derived based on inverse transform (transform) of the scaled transform coefficients. These details may be equally applied or described in other parts of the disclosure.”

As described above, the predictor of the encoding apparatus/decoding apparatus may perform inter prediction on a block basis to derive prediction samples. The inter prediction may refer to prediction derived in a manner dependent on data elements (i.e., sample values, motion information, etc.) of picture(s) other than the current picture. When the inter prediction is applied to the current block, a predicted block (prediction sample array) for the current block may be derived based on a reference block (reference sample array) specified by a motion vector on a reference picture indicated by a reference picture index. Here, to reduce the amount of motion information transmitted in the inter prediction mode, motion information of the current block may be predicted on a block, sub-block, or sample basis, based on a correlation in motion information between a neighboring block and the current block.

The motion information may further include inter prediction direction (L0 prediction, L1 prediction, compound prediction, etc.) information. In the case of inter prediction, the neighboring block may include a spatial neighboring block in a current frame and a temporal neighboring block in a reference frame. A reference frame including the reference block and a reference frame including the temporal neighboring block may be the same or different. The temporal neighboring block may be referred to as a co-located reference block or a co-located block, and the reference frame including the temporal neighboring block may also be referred to as a co-located frame. For example, the inter predictor may construct a motion information stack based on neighboring blocks, and may generate information indicating a candidate used to derive a motion vector and/or a reference frame index of the current block. The motion information stack may be referred to as a motion information list. The motion information stack may include a motion vector stack. The motion vector stack may be referred to as RefStackMv. The motion vector stack may include eight or more candidates. Information about the (maximum) number of candidates of the motion vector stack may be signaled on a frame or sequence basis. For inter prediction, a motion mode may be additionally considered. The motion mode may include a simple mode, an overlapped block motion compensation (OBMC) mode, and/or a local warp mode. The OBMC mode may improve prediction performance for a left and/or upper boundary of the current block by using motion information about a neighboring block, and the local warp mode may apply an affine model in addition to translational motion compensation. Inter prediction may be performed based on various prediction modes, and information about prediction obtainable through the bitstream may include information indicating a mode related to inter prediction for the current block. For example, the inter predictor may construct a motion information stack based on neighboring blocks, and may derive a motion vector and/or a reference frame index of the current block based on received candidate selection information (e.g., a reference motion vector index and/or a reference frame index).

Inter prediction-based video/image encoding procedures and the predictor in the encoding apparatus may perform, for example, the following for inter prediction in general.

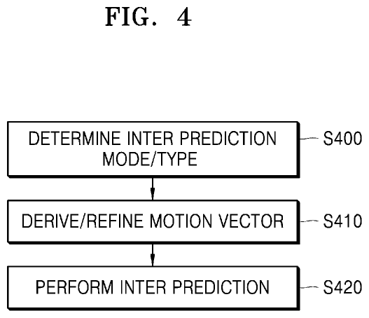

FIG. 4 illustrates an inter prediction procedure.

Referring to FIG. 4, as described above, the inter prediction procedure may include an inter prediction mode/type determination step, a motion vector derivation/refinement step, and an inter prediction performing (prediction sample generation) step. The inter prediction procedure may be performed in the encoding apparatus and the decoding apparatus as described above. In the present document, the coding apparatus may include the encoding apparatus and/or the decoding apparatus. The coding apparatus determines an inter prediction mode/type (S400). The coding apparatus may include the encoding apparatus and/or the decoding apparatus as described above.

The encoding apparatus may determine an inter prediction mode/type to be applied to the current block from among various inter prediction modes/types described in the present disclosure, and may generate prediction related information. The prediction related information may include inter prediction mode information indicating an inter prediction mode applied to the current block and/or inter prediction type information indicating an inter prediction type applied to the current block. The decoding apparatus may determine an inter prediction mode/type applied to the current block based on the prediction related information.

The coding apparatus derives/refines a motion vector of the current block (S410). The coding apparatus may derive/refine the motion vector of the current block based on the determined inter prediction mode/type. Here, motion information of a neighboring block of the current block or signaled prediction related information may be used to derive/refine the motion vector.

For example, a single reference mode or a compound reference mode may be applied to the current block. The single reference mode may also be referred to as a unidirectional inter prediction mode, and the compound reference mode may also be referred to as a bidirectional inter prediction mode. For example, a compound flag indicating whether the single reference mode or the compound reference mode is applied to the current block may be signaled. When the single reference mode is applied, one motion vector may be derived for the current block.

For example, when the NEARMV mode or the NEARESTMV mode is applied to the current block, the decoding apparatus may construct a motion vector candidate list and may select one motion vector candidate from among motion vector candidates included in the motion vector candidate list. The decoding apparatus may derive the motion vector of the current block based on the selected motion vector candidate. Information (e.g., a motion vector candidate index) indicating the selected motion vector candidate may be included in the prediction-related information. Also, the motion vector candidate list may be referred to as a dynamic reference list or RefStackMV, and the motion vector candidate index may also be referred to as a DRL index.

As another example, when the NEW mode is applied to the current block, the decoding apparatus may construct a motion vector candidate list and may derive the motion vector of the current block based on a motion vector of a selected motion vector candidate among motion vector candidates included in the motion vector candidate list and a signaled MVD (motion vector difference). Information (e.g., a motion vector candidate index) indicating the selected motion vector candidate may be included in the prediction related information. In this case, not only the motion vector candidate index but also information about the MVD may be included in the prediction related information. The motion vector candidate list may also be referred to as a dynamic reference list or RefStackMV, and the motion vector candidate index may also be referred to as a DRL index.

Meanwhile, as described below, the motion information of the current block may be derived without constructing a candidate list, and in this case, the motion information of the current block may be derived according to a procedure disclosed in a prediction mode/type described below. In this case, the candidate list construction as described above may be omitted.

For example, when the GLOBAL mode is applied to the current block, the decoding apparatus may derive global motion parameters and a global motion vector for the current block based on global motion parameter information for the current frame, and may perform inter prediction for the current block based on the global motion parameters and the global motion vector.

In addition, for example, when the compound reference mode is applied, a plurality of motion vectors may be derived for the current block.

For example, when the NEAREST_NEARESTMV mode, NEAR_NEARMV mode, NEAREST_NEWMV mode, NEW_NEARESTMV mode, NEAR_NEWMV mode, NEW_NEARMV mode, or NEW_NEWMV mode is applied to the current block, the decoding apparatus may construct a motion vector candidate list and may select at least one motion vector candidate from among motion vector candidates included in the motion vector candidate list. The decoding apparatus may derive motion vectors of the current block based on the selected at least one motion vector candidate. Information (e.g., a motion vector candidate index) indicating the selected at least one motion vector candidate may be included in the prediction related information. The motion vector candidate list may also be referred to as a dynamic reference list or RefStackMV, and the motion vector candidate index may also be referred to as a DRL index.

Meanwhile, for example, when the NEAREST_NEWMV mode, NEW_NEARESTMV mode, NEAR_NEWMV mode, NEW_NEARMV mode, or NEW_NEWMV mode is applied to the current block, the decoding apparatus may derive a motion vector of the current block based on a motion vector of a selected motion vector candidate and a signaled MVD. In this case, not only the motion vector candidate index but also information about the MVD may be included in the prediction related information.

Meanwhile, for example, when the GLOBAL_GLOBALMV mode is applied to the current block, the decoding apparatus may derive global motion parameters and global motion vectors for the current block based on global motion parameter information for the current frame, and may perform inter prediction for the current block based on the global motion parameters and the global motion vectors.

The coding apparatus predicts (generates prediction samples of) the current block based on the derived/refined motion vector (S420). The coding apparatus may derive prediction samples of the current block using samples of a reference block indicated by the motion vector on a reference picture.

The inter prediction-based encoding procedure may include, for example, the following in general.

The inter prediction-based encoding procedure may include, for example, the following in general.

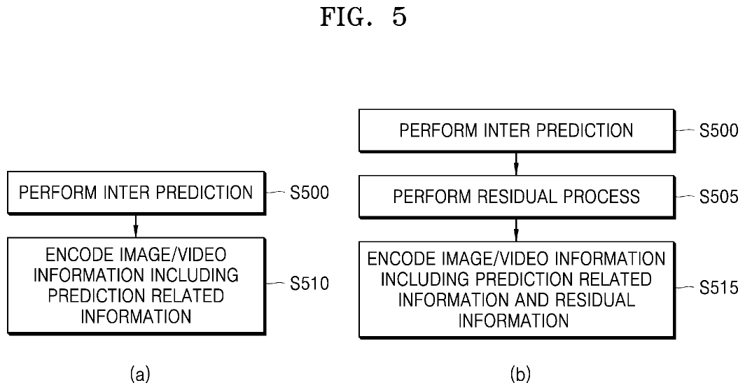

FIG. 5 illustrates examples of inter prediction based video/image encoding methods.

Referring to FIG. 5, S500 may be performed by the predictor of the encoding apparatus, S505 may be performed by the residual processor of the encoding apparatus, and S510 or S515 may be performed by the entropy encoder of the encoding apparatus. Specifically, the prediction related information may be derived by the predictor and encoded by the entropy encoder. The residual information may be derived by the residual processor and encoded by the entropy encoder. The residual information is information about the residual samples. The residual information may include information about quantized transform coefficients for the residual samples. As described above, the residual samples may be derived as transform coefficients through the transformer of the encoding apparatus, and the transform coefficients may be derived as quantized transform coefficients through the quantizer. Information about the quantized transform coefficients may be encoded by the entropy encoder through a residual coding procedure.

The encoding apparatus performs inter prediction on the current block (S500). The encoding apparatus may derive the inter prediction mode/type and motion information of the current block, and may generate prediction samples of the current block. Here, the inter prediction mode/type determination, the motion information derivation, and the prediction sample generation procedure may be performed simultaneously, or one procedure may be performed before another procedure. For example, the inter predictor of the encoding apparatus may search for a block similar to the current block within a certain area (search area) of reference pictures through motion estimation, and may derive a reference block having a minimum or certain criterion or less of a difference from the current block. Based on the same, a reference picture index indicating a reference picture in which the reference block is located may be derived, and a motion vector may be derived based on a position difference between the reference block and the current block. The encoding apparatus may determine a mode to be applied to the current block from among various prediction modes. The encoding apparatus may compare RD costs for the various prediction modes and determine an optimal prediction mode for the current block.

For example, when the NEW mode or NEAR mode is applied to the current block, the encoding apparatus may construct a motion vector candidate list and may derive a reference block having a minimum or certain criterion or less of a difference from the current block among reference blocks indicated by motion vector candidates included in the motion vector candidate list. In this case, a motion vector candidate associated with the derived reference block may be selected, and motion vector index information indicating the selected motion vector candidate may be generated and signaled to the decoding apparatus. Motion information of the current block may be derived using motion information of the selected motion vector candidate.

Alternatively, for example, when the NEAREST mode is applied to the current block, the encoding apparatus may construct a motion vector candidate list and may derive a reference block indicated by a first motion vector candidate among reference blocks indicated by motion vector candidates included in the motion vector candidate list as a reference block having a minimum or certain criterion or less of a difference from the current block. The first motion vector candidate may be a motion vector candidate having an index value of 0 in the motion vector candidate list. In this case, the first motion vector candidate is selected, and motion vector index information may not be signaled. The decoding apparatus may construct the motion vector candidate list and select the first motion vector candidate when the NEAREST mode is applied to the current block. Motion information of the current block may be derived using motion information of the selected motion vector candidate.

The encoding apparatus may perform residual processing based on the prediction samples (S505). The encoding apparatus may derive residual samples based on the prediction samples. The encoding apparatus may derive the residual samples through comparison of original samples of the current block and the prediction samples. Residual information may be generated based on the residual samples. The residual information may include information about the quantized transform coefficients as described above.

The encoding apparatus encodes image information including prediction related information and/or residual information (S510 or S515). The encoding apparatus may output the encoded image information in a form of a bitstream. The prediction related information may be information related to the prediction procedure, and may include prediction mode information (e.g., skip_mode, compound_mode, new_mv, zero_mv, ref_mv, etc.) and/or information about the motion information. The information about the motion information may include motion type information (e.g., motion_mode) and/or candidate selection information (e.g., drl_mode), which is information for deriving the motion vector. The information about the motion information may further include information about the MVD described above and/or reference picture index information. In addition, for example, the motion type information may indicate whether a motion compensation type of the current block is a SIMPLE type that is a general inter prediction using a motion vector, an overlapped block motion compensation (OBMC) type, or a LOCALWARP type. The SIMPLE type may represent translational motion compensation, the OBMC type may improve prediction performance for a left and/or upper boundary of the current block by using motion information about a neighboring block, and the local warp type may apply an affine model in addition to translational motion compensation. The residual information is information about the residual samples. The residual information may include information about the quantized transform coefficients for the residual samples.

The output bitstream may be stored in a (digital) storage medium and delivered to the decoding apparatus, or may be delivered to the decoding apparatus through a network.

Meanwhile, as described above, the encoding apparatus may generate a reconstructed picture (including reconstructed samples and a reconstructed block) based on the reference samples and the residual samples. This is for deriving the same prediction result in the encoding apparatus as that performed in the decoding apparatus, and coding efficiency may be enhanced through this. Therefore, the encoding apparatus may store the reconstructed picture (or reconstructed samples, a reconstructed block) in the memory and utilize the same as a reference picture for inter prediction. An in-loop filtering procedure and the like may be further applied to the reconstructed picture as described above.

The decoding apparatus may perform an operation corresponding to the operation performed in the encoding apparatus. The inter prediction-based video/image decoding procedure may include, for example, the following.

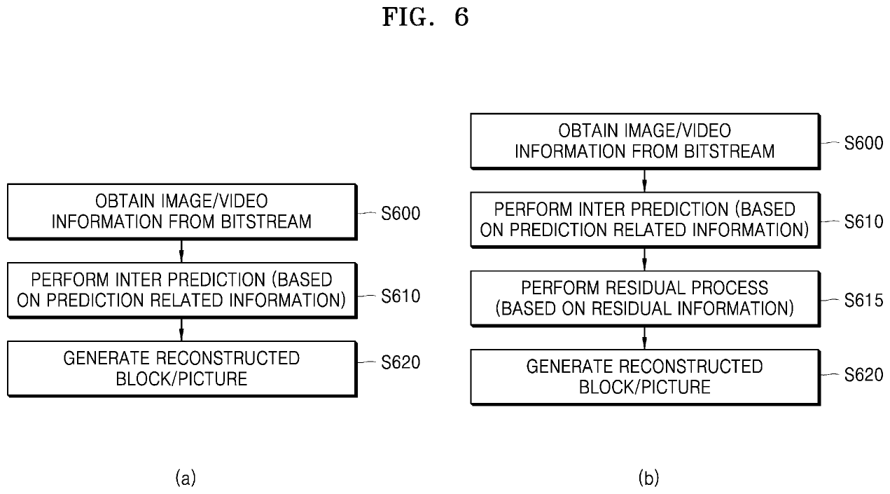

FIG. 6 illustrates examples of inter prediction based video/image decoding methods.

Referring to FIG. 6, S600 may be performed by the entropy decoder of the decoding apparatus, S610 may be performed by the predictor of the decoding apparatus, S615 may be performed by the residual processor of the decoding apparatus, and S620 may be performed by the adder or the reconstructor of the decoding apparatus.

Specifically, the decoding apparatus obtains image/video information from a bitstream (S600). The image/video information may include prediction related information and/or residual information.

The decoding apparatus performs inter prediction based on the prediction related information (S610). The decoding apparatus may derive an inter prediction mode/type for the current block based on the prediction related information, derive/refine motion information of the current block, and may generate prediction samples in the current block based on the inter prediction mode/type and/or the motion information. In this case, the decoding apparatus may perform a prediction sample filtering procedure. The prediction sample filtering may be referred to as post filtering. Some or all of the prediction samples may be filtered by the prediction sample filtering procedure. In some cases, the prediction sample filtering procedure may be omitted.

The decoding apparatus performs residual processing based on the residual information (S615). The decoding apparatus may derive residual samples for the current block based on the residual information. Specifically, the dequantizer of the residual processor may perform dequantization based on quantized transform coefficients derived based on the residual information to derive transform coefficients, and the inverse transformer of the residual processor may perform inverse transform on the transform coefficients to derive the residual samples for the current block.

The decoding apparatus generates a reconstructed block/picture (S620). The decoding apparatus may generate reconstructed samples for the current block based on the prediction samples and/or the residual samples, and may derive a reconstructed block including the reconstructed samples. A reconstructed picture for the current picture may be generated based on the reconstructed block. An in-loop filtering procedure and the like may be further applied to the reconstructed picture as described above.

The prediction related information may be encoded/decoded through binarization and coding methods described in the present document. For example, the prediction related information may be binarized through fixed-length binarization, truncated Rice binarization, truncated unary binarization, and the like. For example, the prediction related information may be encoded/decoded through entropy coding (e.g., CABAC, CAVLC).

Meanwhile, when inter prediction is applied to the current block, the inter prediction mode/type of the current block may be derived as follows.

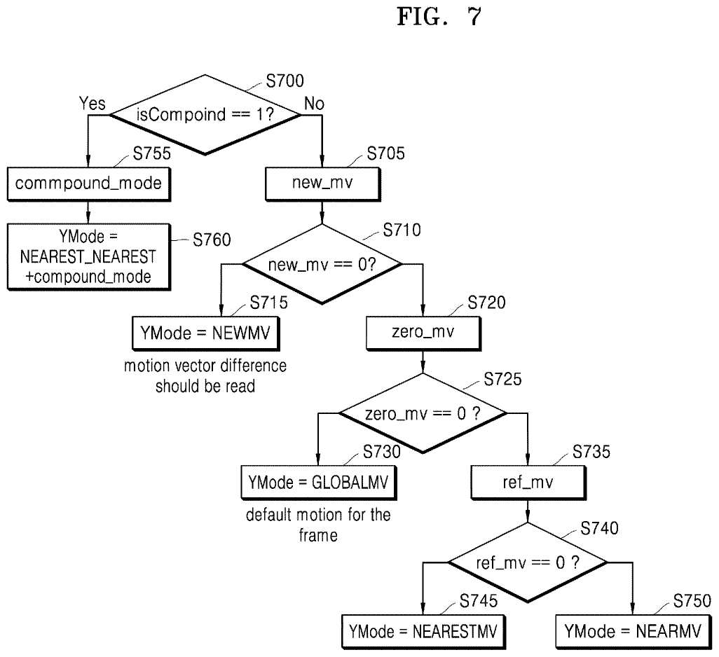

FIG. 7 illustrates an example of a method of determining an inter prediction mode/type of a current block.

The decoding apparatus may determine whether is Compound is 1 (S700). The decoding apparatus may determine whether a value of is Compound is 1. Here, is Compound may be a variable indicating whether compound prediction is applied to the current block. For example, when the value of is Compound is 1, is Compound may indicate that compound prediction is applied to the current block, and when the value of is Compound is 0, is Compound may indicate that single prediction is applied to the current block. The compound prediction may also be referred to as compound inter prediction, and the single prediction may also be referred to as single inter prediction.

For example, the variable is Compound may be derived based on a value of a reference frame index indicating a reference frame 1 of the current block. For example, when the reference frame index indicating the reference frame 1 does not indicate NONE, the value of is Compound may be derived as 1, and when the reference frame index indicating the reference frame 1 indicates NONE, the value of is Compound may be derived as 0. For example, when the value of the reference frame index indicating the reference frame 1 is −1, the reference frame index indicating the reference frame 1 may indicate NONE. NONE may mean that single prediction is applied.

When is Compound is not 1, the decoding apparatus may obtain new_mv (S705) and may determine whether new_mv is 0 (S710). When is Compound is not 1, new_mv for the current block may be signaled. The new_mv may indicate whether the MVD of the current block exists. The new_mv may be referred to as a newmv mode index.

When new_mv is 0, the decoding apparatus may derive the NEWMV mode as the inter prediction mode of the current block (S715). When new_mv is 0, the MVD of the current block may be signaled.

When new_mv is 1, the decoding apparatus may obtain zero_mv (S720) and may determine whether zero_mv is 0 (S725). When new_mv is 1, zero_mv for the current block may be signaled. The zero_mv may indicate whether the motion vector of the current block is set to be the same as a default motion vector of the current frame. The zero_mv may be referred to as a zeromv mode index or a GLOBALMV mode index. Also, the default motion vector of the current frame may be referred to as a global motion vector.

When zero_mv is 0, the decoding apparatus may derive the GLOBALMV mode as the inter prediction mode of the current block (S730). When zero_mv is 0, the motion vector of the current block may be derived as the global motion vector of the current frame.

When zero_mv is 1, the decoding apparatus may obtain ref_mv (S735) and may determine whether ref_mv is 0 (S740). When zero_mv is 1, ref_mv for the current block may be signaled. When ref_mv is 0, it may mean that the most likely motion vector (i.e., NEAREST) is used, and when ref_mv is 1, it may mean that the second most likely motion vector (i.e., NEAR) is used. The ref_mv may be referred to as a refmv mode index.

That is, for example, when ref_mv is 0, the decoding apparatus may derive the NEARESTMV mode as the inter prediction mode of the current block (S745), and when ref_mv is 1, the decoding apparatus may derive the NEARMV mode as the inter prediction mode of the current block (S750).

Meanwhile, when is Compound is 1, the decoding apparatus may obtain compound_mode (S755) and may derive a NEAREST_NEAREST+compound_mode mode as the inter prediction mode of the current block (S760). When is Compound is 1, compound prediction may be applied to the current block. The compound_mode may be referred to as a compound mode index.

The decoding apparatus may derive a compound reference mode of the current block based on compound_mode. For example, compound reference modes may be as shown in the following table.

TABLE 1

| YMode | Name of YMode |
|---|---|
| 14 | NEARESTMV |
| 15 | NEARMV |
| 16 | GLOBALMV |
| 17 | NEWMV |
| 18 | NEAREST_NEARESTMV |
| 19 | NEAR_NEARMV |
| 20 | NEAREST_NEWMV |
| 21 | NEW_NEARESTMV |
| 22 | NEAR_NEWMV |
| 23 | NEW_NEARMV |
| 24 | GLOBAL_GLOBALMV |
| 25 | NEW_NEWMV |

For example, the decoding apparatus may derive a prediction mode of the current block by adding an offset to compound_mode. For example, the decoding apparatus may derive a prediction mode corresponding to a value obtained by adding compound_mode to 18, which is an index value representing NEAREST_NEAREST, as the prediction mode of the current block. For example, when the value of compound_mode is n, the decoding apparatus may derive the 18+n mode as the prediction mode of the current block.

In addition, in performing inter prediction, a translational motion model between a reference block and the current block is typically assumed, but warp prediction utilizing warped motion information with a supported affine model may be supported. The affine motion model may be represented by the following equation.

$$[ \begin{matrix}{x}^{′} \\ {y}^{′}\end{matrix} ] = [ \begin{matrix}{a}_{1} & {a}_{2} & {a}_{3} \\ {b}_{1} & {b}_{2} & {b}_{3}\end{matrix} ] \cdot [ \begin{matrix}x \\ y \\ 1\end{matrix} ] \qquad [ Equation 1 ]$$

Here, [x, y] may be coordinates of an original pixel (i.e., coordinates of a sample of the current block), and [x′, y′] may be warped coordinates of the reference block. In addition, according to the above equation, a maximum of six parameters are needed to specify warped motion, where a3 and b3 specify a translational MV; a1 and b2 specify scaling along the MV; and a2 and b1 specify rotation. The a1, a2, a3, b1, b2, and b3 may be referred to as WARP parameters.

For example, a GLOBALWARP type and a LOCALWARP type may be supported as inter prediction modes for deriving warp parameters. For example, when the GLOBALMV mode or the GLOBAL_GLOBALMV mode is applied to the current block and the type of the global motion vector of the current frame is an affine type, the GLOBALWARP type may be applied to the current block. In addition, for example, motion type information of the current block may indicate whether a motion compensation type of the current block is a SIMPLE type that is a general inter prediction using a motion vector, an overlapped block motion compensation (OBMC) type, or a LOCALWARP type. When the motion type information of the current block indicates that the motion compensation type of the current block is the LOCALWARP type, the LOCALWARP type may be applied to the current block. The GLOBALWARP type may be referred to as a GLOBAL WARP mode, and the LOCALWARP type may be referred to as a LOCAL WARP mode.

For example, after a reference frame index is signaled, global motion compensation may be selected for the current block. That is, for example, the GLOBALMV mode or the GLOBAL_GLOBALMV mode may be applied to the current block. When global motion compensation is selected, a WARP parameter associated with a global motion type and a reference frame indicated by a reference frame index may be used for the current block.

For example, global motion types as shown in the following table may be used for the current block.

TABLE 2

| Global motion type | Number of parameters |
|---|---|
| Identity | 0 |
| Translation | 2 |
| Rotation | 4 |
| Zoom | 4 |
| Affine | 6 |

For example, when global motion compensation is selected, a global motion type of the current block within the current frame may be derived based on global motion type information of the current frame, and a WARP parameter associated with a reference frame according to the global motion type may be used for the current block. For example, when the global motion type is a translation type, a3 and b3 associated with the reference frame may be derived as WARP parameters of the current block, and when the global motion type is a rotation type, a2, a3, b1, and b3 associated with the reference frame may be derived as WARP parameters of the current block, and when the global motion type is a zoom type, a1, a3, b2, and b3 associated with the reference frame may be derived as WARP parameters of the current block, and when the global motion type is an affine type, a1, a2, a3, b1, b2, and b3 associated with the reference frame may be derived as WARP parameters of the current coding block.

For example, when warp prediction is applied, global warped motion compensation or local warped motion compensation may be applied.

In addition, local warped motion compensation may be selected. That is, for example, the LOCAL WARP mode may be applied to the current block.

For example, local warped motion compensation may be allowed when the current block satisfies the following conditions. First, the current block uses unidirectional prediction (single reference prediction), second, the width or height of the current block should be 8 or more, and lastly, at least one of adjacent neighboring blocks should use the same reference frame as the current block. The above conditions for allowing local warped motion compensation for the current block are merely examples and are not limited thereto.

For example, when local warped motion compensation is used for the current block, WARP parameters (affine model parameters) may be estimated by minimizing the average squared difference between reference and modeled projections based on MVs of the current block and neighboring blocks. To estimate WARP parameters of local warped motion compensation, when a neighboring block uses the same reference frame as the current block, a projection sample pair of a center sample in the neighboring block and a sample corresponding to the center sample in the reference frame may be obtained. Subsequently, three extra samples may be generated by shifting the center position by ¼ sample in one or two dimensions. The extra samples may also be considered as projection sample pairs to ensure stability of the model parameter estimation process.

In addition, MVs of neighboring blocks used for deriving warp parameters may be referred to as motion samples. The motion samples may be derived from neighboring blocks using the same reference frame as the current block. That is, the LOCAL WARP mode may be available only for blocks using a single reference frame.

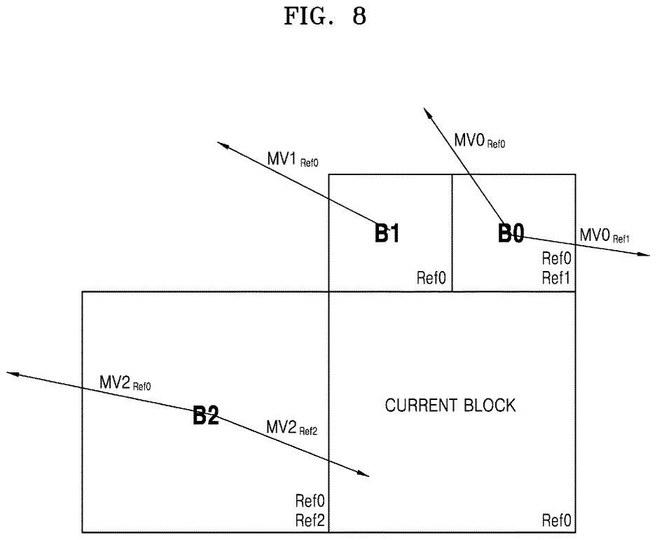

FIG. 8 illustrates an example of motion samples used to derive WARP parameters of a current block to which the LOCAL WARP mode is applied.

Referring to FIG. 8, MVs of neighboring blocks B0, B1, and B2 may be represented as MV0, MV1, and MV2, respectively. For example, unidirectional reference prediction using a reference frame 0 (Ref0) may be applied to the current block, compound reference prediction using reference frames (Ref0 and Ref1) may be applied to a neighboring block B0, unidirectional reference prediction using the reference frame 0 (Ref0) may be applied to a neighboring block B1, and compound reference prediction using reference frames (Ref0 and Ref2) may be applied to a neighboring block B2. In this case, motion vectors for the same reference frame as the current block, which are MV0_{Ref0} of B0, MV1_{Ref0} of B1, and MV2_{Ref0} of B2, may be used as motion samples for deriving WARP parameters of the current block.

Meanwhile, in addition to existing modes for deriving warp parameters, a WARP EXTEND mode supporting continuous extension of a warp model of a neighboring block to motion compensation of the current block and a WARP delta mode signaling a WARP delta may be proposed.

For example, the WARP EXTEND mode may refer to a mode that modifies warp parameters while extending a motion vector of a neighboring block to the current block. Through this, complex warping motions may be represented while minimizing blocking artifacts, and it may be possible to spread the warping motion across a plurality of blocks.

For example, the WARP EXTEND mode may be applied to a NEWMV block (i.e., a block to which the NEWMV mode is applied). That is, for example, when the NEWMV mode is applied to the current block, it may be determined whether the WARP EXTEND mode is applied to the current block.

The WARP EXTEND mode applied to a NEWMV block may derive a new warp model based on two constraints. For example, motion vectors for each sample according to the warp model derived by applying the WARP EXTEND mode should be continuous with motion vectors for each sample in a neighboring block, and a motion vector at a center sample of the current block should match a motion vector signaled for the current block.

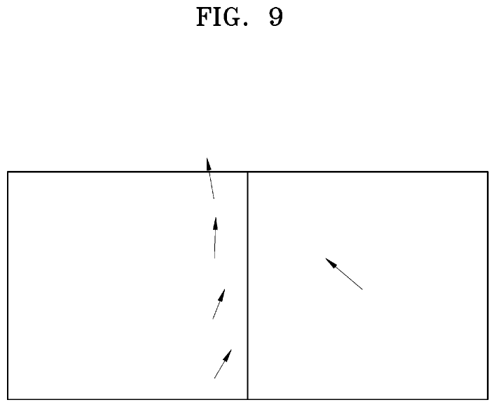

FIG. 9 illustrates an example of motion vectors of the current block to which the WARP EXTEND mode is applied.

Referring to FIG. 9, when the WARP EXTEND mode is applied to the current block, warp parameters may be derived based on a left neighboring block of the current block. That is, for example, the warp model of the left neighboring block may be used as the warp model of the current block.

Specifically, for example, specific equations involving warp parameters of the neighboring block and the current block may be derived according to the two constraints. The equations may be solved to calculate the warp model for the current block. For example, when (A, . . . , F) represents a warp model (i.e., warp parameters) of the neighboring block and (A′, . . . , F′) represents a new warp model (i.e., warp parameters), the first constraint may be represented by the following equation at each point along a common edge.

$$( \begin{matrix}{A}^{′} & {B}^{′} \\ {C}^{′} & {D}^{′}\end{matrix} ) ( \begin{matrix}x \\ y\end{matrix} ) + ( \begin{matrix}{E}^{′} \\ {F}^{′}\end{matrix} ) = ( \begin{matrix}A & B \\ C & D\end{matrix} ) ( \begin{matrix}x \\ y\end{matrix} ) + ( \begin{matrix}E \\ F\end{matrix} ) \qquad [ Equation 2 ]$$

Referring to FIG. 9, the common edge of the current block and the left neighboring block may be left-end samples of the current block where the current block is adjacent to the left neighboring block. Samples of the common edge of the current block and the left neighboring block have different y values, but all have the same x value. Therefore, the warp model of the left neighboring block and the warp model of the current block should have the same warp parameters for y. That is, B′=B and D′=D. For example, equations for the warp parameters for y may be represented as follows.

$${B}^{′} = B \qquad [ Equation 3 ]$$

$${D}^{′} = D$$

In addition, for example, equations for the warp parameters for x may be represented as follows.

$${A}^{′} x + {E}^{′} = Ax + E \qquad [ Equation 4 ]$$

$${C}^{′} x + {F}^{′} = Cx + F$$

Here, x is a horizontal position of the samples and is therefore essentially a constant.

In addition, the second constraint described above may be that a motion vector at a center sample of the current block should be the same as a motion vector of the current block signaled in the NEWMV mode. Two additional equations may be derived from the second constraint, and accordingly, a system of six equations for deriving six warp parameters (A′, B′, C′, D′, E′, F′) of the current block may be derived. That is, the warp parameters of the current block may be derived based on the equations of Equation 6, the equations of Equation 7, and the two additional equations derived from the second constraint. The warp parameter derivation process according to the WARP EXTEND mode is less complex than the least-squares-based LOCAL WARP mode described above.

Meanwhile, for example, a plurality of neighboring blocks from which the warp model may be extended, i.e., neighboring blocks available in the WARP EXTEND mode, may exist, and a method for selecting a neighboring block for deriving the warp model of the current block from among the neighboring blocks may be proposed.

Specifically, for example, a plurality of available motion vectors may be derived from neighboring blocks. In this case, a neighboring block may be selected in the same manner as deriving motion information of the current block in the NEWMV mode. For example, a warp model candidate indicated by a warp model index of the current block may be selected from among warp model candidates derived from neighboring blocks of the current block. In addition, for example, the WARP EXTEND mode may be available only when a warp model is derived from an adjacent neighboring block of the current block. That is, for example, the WARP EXTEND mode may be available only when an adjacent neighboring block of the current block is predicted with a warp model.

Alternatively, for example, without signaling a warp model index, neighboring blocks may be sequentially checked, and a warp model predictor of the current block may be derived based on a warp model determined as the first available neighboring block. Alternatively, for example, it may be determined whether a preset neighboring block is available, and when the preset neighboring block is available, the warp model predictor of the current block may be derived based on a warp model of the preset neighboring block. The preset neighboring block may be a left neighboring block or a top neighboring block of the current block. Whether a neighboring block is available may depend on whether the neighboring block is a neighboring block on which inter prediction is performed based on a warp model. The warp model predictor may represent warp parameters of the neighboring block used for deriving warp parameters of the current block.

Meanwhile, a case in which the warp model of the neighboring block is used as is without requiring additional modification may be favorable. To code this case, WARP_EXTEND may be used for NEARMV blocks. That is, the WARP EXTEND mode may be applied to a NEARMV block (i.e., a block to which the NEARMV mode is applied). For example, when the NEARMV mode is applied to the current block, it may be determined whether the WARP EXTEND mode is applied to the current block.

For example, the WARP EXTEND mode applied to a NEARMV block may be the same as the WARP EXTEND mode applied to the NEWMV block described above, except that it requires a neighboring block to be coded with a warp model. For example, when the neighboring block is coded with a warp model and the WARP EXTEND mode is selected for the current block, warp parameters of the neighboring block of the current block may be copied to the current block. That is, for example, when the neighboring block is coded with a warp model and the WARP EXTEND mode is selected for the current block, warp parameters of the neighboring block of the current block may be derived as warp parameters of the current block.

In addition, for example, a WARP EXTEND index indicating whether the WARP EXTEND mode is applied may be signaled. For example, the WARP EXTEND index may be represented as warp_extend. For example, the WARP EXTEND index indicating whether the WARP EXTEND mode is applied may be signaled when motion type information (motion_mode) of the current block indicates that the motion compensation type is LOCALWARP. When the value of the WARP EXTEND index is 1, it may indicate that the WARP EXTEND mode is applied to the current block, and when the value of the WARP EXTEND index is 0, it may indicate that the WARP EXTEND mode is not applied to the current block. When the WARP EXTEND index is not signaled, the value of the WARP EXTEND index may be inferred as 0. Alternatively, for example, when the value of the WARP EXTEND index is 0, it may indicate that the WARP EXTEND mode is applied to the current block, and when the value of the WARP EXTEND index is 1, it may indicate that the WARP EXTEND mode is not applied to the current block. When the WARP EXTEND index is not signaled, the value of the WARP EXTEND index may be inferred as 1.

Alternatively, for example, the WARP EXTEND index indicating whether the WARP EXTEND mode is applied may be signaled only when useWarp of the current block is not 0. The useWarp may be a variable indicating whether WARP prediction of the current block is applied. For example, when useWarp is 1, useWarp may indicate that the LOCAL WARP mode is applied to the current block, and when useWarp is 2, useWarp may indicate that the GLOBAL WARP mode is applied to the current block. That is, for example, when warp prediction is applied to the current block, the WARP EXTEND index indicating whether the WARP EXTEND mode is applied to the current block may be signaled. Accordingly, the WARP EXTEND mode may also be applied when global warping (GLOBAL WARP mode) is applied to the current block.

Alternatively, for example, the WARP EXTEND index indicating whether the WARP EXTEND mode is applied may be signaled only when useWarp of the current block is 1. The useWarp may be a variable indicating whether WARP prediction of the current block is applied. When the value of useWarp is 1, it may indicate that local warping (LOCAL WARP mode) is applied to the current block, and when the value of useWarp is 2, it may indicate that global warping (GLOBAL WARP mode) is applied to the current block. That is, for example, when the LOCAL WARP mode is applied to the current block, the WARP EXTEND index may be signaled. Accordingly, the WARP EXTEND mode may only be applied when local warping is applied to the current block.

In addition, for example, a WARP DELTA mode may be supported. For example, the WARP DELTA mode may refer to a mode for deriving a warp model of the current block based on a predicted warp model (i.e., predicted warp parameters) and a signaled warp delta, similar to the manner in which the MV of the current block is derived based on an MVP predicted from a motion vector of a neighboring block and a signaled MVD. The predicted warp model may be derived from a global warp model (if available) or from a neighboring block.

Meanwhile, various restrictions may be applied to avoid duplication of a plurality of methods for encoding the same predicted warp model. For example, when the prediction mode of the current block is the NEARMV mode or the NEWMV mode, the same neighboring block selection logic as the WARP EXTEND mode described above may be used in the WARP DELTA mode. For example, when the prediction mode of the current block is the NEARMV mode or the NEWMV mode, when the WARP DELTA mode is applied to the current block, warp model candidates may be derived based on neighboring blocks to which a warp model is applied, and a warp model candidate indicated by a warp model index may be derived as a warp model predictor of the current block among the warp model candidates. When no neighboring block to which a warp model is applied exists, a global warp model may be derived as the warp model predictor of the current block. Here, the warp model predictor may represent warp parameters used for deriving the warp parameters of the current block.

In addition, for example, when the WARP DELTA mode is applied, deltas of non-translational parameters among the warp parameters of the current block may be coded and signaled. The non-translational parameters may include warp parameters a1 and b2 specifying scaling and warp parameters a2 and b1 specifying rotation described above. The deltas of the non-translational parameters may be referred to as warp delta information of the current block. Subsequently, the warp model of the current block may be derived based on the signaled deltas for the non-translational warp parameters for the warp model predictor of the current block. In addition, a translational portion (i.e., translational parameters a3 and b3) of the warp model may be adjusted so that a per-sample motion vector at the center sample of the current block matches the overall motion vector of the current block. The overall motion vector of the current block may be derived based on the signaled prediction-related information.

Meanwhile, since the WARP DELTA mode involves explicitly coding a delta of a warp parameter, more bits may be used compared to other warp modes. Therefore, for example, the WARP DELTA mode may not be available for blocks smaller than 16×16. However, the decoding logic is very simple, and thus may have the effect of representing complex motion compensation that is difficult with other warp modes.

In addition, for example, a WARP DELTA index indicating whether the WARP DELTA mode is applied may be signaled. For example, a syntax indicating whether the WARP DELTA mode is applied may be signaled when useWarp of the current block is not 0. The useWarp may be a variable indicating whether WARP prediction of the current block is applied. For example, when useWarp is 1, useWarp may indicate that the LOCAL WARP mode is applied to the current block, and when use Warp is 2, useWarp may indicate that the GLOBAL WARP mode is applied to the current block. That is, for example, when warp prediction is applied to the current block, a WARP DELTA index indicating whether the WARP DELTA mode is applied to the current block may be signaled. Accordingly, the WARP DELTA mode may be applied when global warping (GLOBAL WARP mode) or local warping (LOCAL WARP mode) is applied to the current block.

In addition, for example, in relation to the WARP EXTEND mode described above, whether the WARP EXTEND mode is applied may be determined, and when the WARP EXTEND mode is not applied, a WARP DELTA index indicating whether the WARP DELTA mode is applied may be signaled. For example, the WARP EXTEND index may be signaled when useWarp of the current block is not 0, and when the WARP EXTEND index indicates that the WARP EXTEND mode is not applied to the current block, a WARP DELTA index indicating whether the WARP DELTA mode is applied to the current block may be signaled.

Alternatively, for example, in relation to the WARP EXTEND mode described above, whether the WARP DELTA mode is applied may be determined, and when the WARP DELTA mode is not applied, a WARP EXTEND index indicating whether the WARP EXTEND mode is applied may be signaled. For example, the WARP DELTA index may be signaled when use Warp of the current block is not 0, and when the WARP DELTA index indicates that the WARP DELTA mode is not applied to the current block, a WARP EXTEND index indicating whether the WARP EXTEND mode is applied to the current block may be signaled.

Meanwhile, for example, a TIP (Temporally Interpolated Prediction) mode may be proposed as an inter prediction mode. The TIP mode may refer to a prediction mode for performing inter prediction based on a reference frame derived by interpolating reference frames. The reference frame derived by interpolating the reference frames may be referred to as a TIP reference frame.

For example, when the TIP mode is applied, a TIP reference frame may be generated based on reference frames of the current frame. For example, the TIP reference frame may be generated by interpolating the reference frames of the current frame.

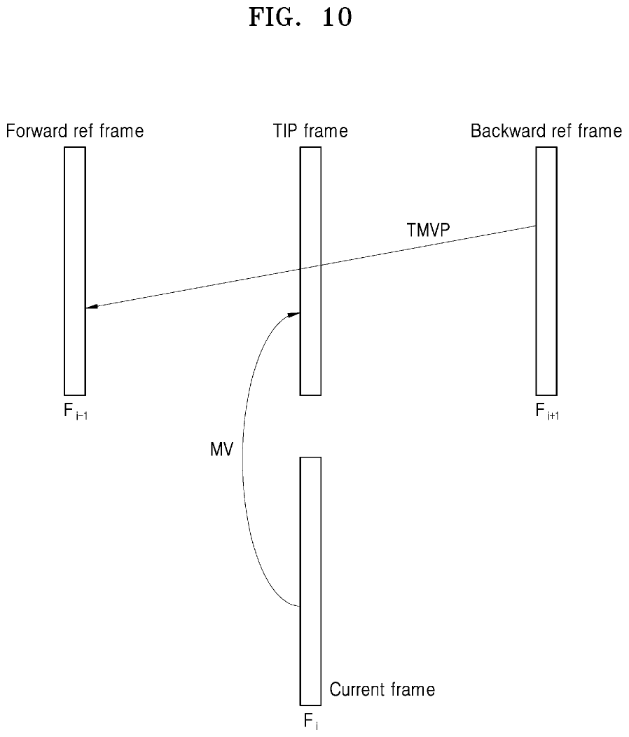

FIG. 10 illustrates an embodiment of performing inter prediction based on a TIP reference frame of a current frame.

For example, referring to FIG. 10, a TIP reference frame of the current frame may be generated based on a backward reference frame of the current frame and a forward reference frame of the current frame. For example, generating the TIP reference frame based on the backward reference frame and the forward reference frame may include using motion vectors of the backward reference frame and the forward reference frame to generate a motion field for the current frame, and using a motion field to fetch (i.e., through interpolation) a reference block in the TIP reference frame.

For example, a motion field based on the backward reference frame and the forward reference frame of the current frame may be used. For example, as illustrated in FIG. 10, the current frame may be denoted as Fi, the backward reference frame may be denoted as Fi−i, and the forward reference frame may be denoted as Fi+i.

For example, the backward reference frame and the forward reference frame may be spaced apart from the current frame by the same distance in a display order of a video sequence. Alternatively, for example, the backward reference frame and the forward reference frame may be reference frames spaced apart from the current frame by different distances in the display order. The temporal motion vector predictor of FIG. 10 may be a motion vector predictor pointing from the backward reference frame to the forward reference frame. A motion vector pointing from the current frame (a specific block, tile, or region of the current frame) to the generated TIP reference frame (a specific block, tile, or region of the TIP reference frame) may represent a motion vector usable for predicting the specific block, tile, or area of the current frame based on the specific block, tile, or area of the generated TIP reference frame.

For example, the TIP reference frame may be generated by interpolating the backward reference frame and the forward reference frame based on a first distance between the backward reference frame and the current frame and a second distance between the forward reference frame and the current frame. Alternatively, for example, a TIP reference region (or TIP reference tile or TIP reference block) of the TIP reference frame may be generated by interpolating a first region (or first tile or first block) of the backward reference frame and a second region (or second tile or second block) of the forward reference frame indicated by a motion vector of the first region of the backward reference frame based on the first distance and the second distance. The first distance may represent a distance between the backward reference frame and the current frame, and the second distance may represent a distance between the forward reference frame and the current frame.

For example, a prediction mode of a current frame may be derived as the TIP prediction mode based on prediction related information of the current frame through a bitstream, and a TIP reference frame may be generated by interpolating a backward reference frame and a forward reference frame of the current frame.

Subsequently, motion information of a current block may be derived based on inter prediction related information of the current block, and a prediction sample of the current block may be derived based on a reference block in the TIP reference frame indicated by the motion information.

Alternatively, for example, when a value of a reference frame index of a current block through the bitstream is a specific value, the reference frame index may indicate a TIP reference frame. For example, when the value of the reference frame index of the current block is a specific value, TIP prediction may be applied to the current block, and the TIP reference frame may be generated by interpolating a backward reference frame and a forward reference frame of the current frame. For example, the specific value may be preset.

Subsequently, motion information of the current block may be derived based on prediction related information of the current block, and a prediction sample of the current block may be derived based on a reference block in the TIP reference frame indicated by the motion information.

Alternatively, for example, index information indicating reference frames for deriving the TIP reference frame may be signaled. For example, a backward reference frame and a forward reference frame of the current frame may be derived based on the signaled index information indicating the reference frames, and the TIP reference frame may be generated by interpolating the backward reference frame and the forward reference frame of the current frame. For example, the index information indicating the reference frames for deriving the TIP reference frame may be signaled in a frame header syntax.

Alternatively, for example, the interpolation may not be limited to the backward reference frame and the forward reference frame. That is, for example, two reference frames may be derived, and the TIP reference frame may be generated by interpolating the reference frames. For example, index information indicating reference frames for deriving the TIP reference frame may be signaled. Two reference frames of the current frame may be derived based on the signaled index information indicating the reference frames, and the TIP reference frame may be generated by interpolating the reference frames of the current frame. For example, the index information indicating the reference frames for deriving the TIP reference frame may be signaled in a frame header syntax.

In addition, when the compound reference prediction described above is applied, a motion vector predictor 0 (MVP0) for a reference frame 0 and a motion vector predictor 1 (MVP1) for a reference frame 1 may be derived, an MVD0 for the reference frame 0 and an MVD1 for the reference frame 1 may be derived, a motion vector 0 (MV0) for the reference frame 0 may be derived based on the MVP0 and the MVD0, and a motion vector 1 (MV1) for the reference frame 1 may be derived based on the MVP1 and the MVD1. Meanwhile, the reference frame 0 may also be referred to as a first reference frame, and the reference frame 1 may also be referred to as a second reference frame.

The MVD0 and the MVD1 may be derived based on MVD related information signaled through the bitstream. According to the various compound reference modes described above, two MVDs may be individually signaled or jointly signaled in the bitstream.

Alternatively, for example, joint MVD coding for deriving MVD0 and MVD1 based on signaled MVD related information may be applied.

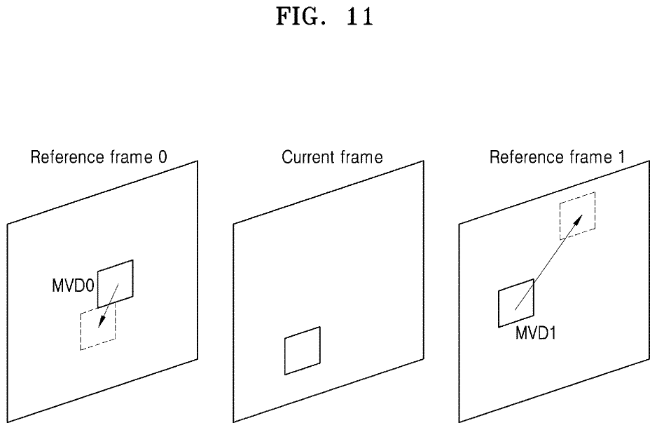

FIG. 11 illustrates an embodiment of deriving MVDs for reference frames based on a joint MVD.

For example, in addition to the NEAR_NEARMV, NEAR_NEWMV, NEW_NEARMV, NEW_NEWMV, and GLOBAL_GLOBALMV modes described above, another inter prediction mode referred to as JOINT_NEWMV may be introduced for a mode in which MVDs for a reference frame 0 and a reference frame 1 are jointly signaled. Specifically, when the inter prediction mode is indicated as NEW_NEWMV, MVDs for the reference frame 0 and the reference frame 1 are individually signaled, whereas when the inter prediction mode is indicated as the JOINT_NEWMV mode, MVDs for the reference frame 0 and the reference frame 1 may be jointly signaled. That is, when the inter prediction mode is indicated as the JOINT_NEWMV mode, one piece of MVD related information for the MVD for the reference frame 0 and the MVD for the reference frame 1 may be signaled.

For example, when the compound reference mode is applied to the current block, a joint_newmv syntax indicating whether the JOINT_NEWMV is applied may be signaled. When the value of the joint_newmv syntax is 1, the prediction mode of the current block may be derived as JOINT_NEWMV, and when the value of the joint_newmv syntax is 0, the prediction mode of the current block may be derived as NEW_NEWMV.

Alternatively, for example, when a value obtained by adding an offset to compound_mode is a specific value, the prediction mode of the current block may be derived as JOINT_NEWMV. That is, for example, whether the prediction mode of the current block is JOINT_NEWMV may be determined based on compound_mode. The offset may be an index value representing NEAREST_NEAREST, and the specific value may be a preset value.

For example, when JOINT_NEWMV is applied to the current block, joint MVD information (e.g., joint_mvd) for one MVD may be signaled in the bitstream, and MVDs for a reference frame 0 and a reference frame 1 may be derived from the joint_mvd. Then, two motion vectors for finding reference blocks for compound inter prediction may be generated by combining the derived MVDs with reference motion vectors in the reference frame 0 or the reference frame 1. The reference motion vector may be referred to as an MVP (motion vector predictor).

For example, scaling of the signaled joint MVD may be performed to obtain one or both of the two MVDs (MVD0 and MVD1). In other words, at least one of MVD0 and MVD1 may be derived by scaling the signaled joint MVD. As a result of the scaling, the precision or pixel resolution of the scaled MVD may differ from the allowed precision of the motion vector difference.

In some exemplary implementations, such MVD(s) that are scaled from the jointly signaled MVD may first be quantized to the allowed precision of the MV(s) for the current picture or slice or tile or superblock or coded block before being added to reference MV(s) to generate motion vector(s).

For example, the JOINT_NEWMV mode may be signaled, and when a POC distance between the reference frame 0 and the current frame and a POC distance between the reference frame 1 and the current frame are different, MVD0 and/or MVD1 may be derived by scaling the joint MVD based on the POC distances.

Specifically, a distance between the reference frame 0 and the current frame may be denoted as td0, and a distance between reference frame 1 and the current frame may be denoted as td1. For example, when td0 is greater than or equal to td1, the joint MVD (i.e., joint_mvd) may be derived as MVD0, and MVD1 may be derived by scaling the joint MVD as shown in the following equation.

$$MVD 1 = \frac{td 1}{td 0} \cdot joint\_mvd \qquad [ Equation 5 ]$$

Here, joint_mvd may represent the signaled joint MVD, td0 may represent the distance between the reference frame 0 and the current frame, and td1 may represent the distance between the reference frame 1 and the current frame.

Alternatively, for example, when td1 is greater than or equal to td0, the joint MVD may be derived as MVD1, and MVD0 may be derived by scaling the joint MVD as shown in the following equation.

$$MVD 0 = \frac{td 0}{td 1} \cdot joint\_mνd \qquad [ Equation 6 ]$$

Here, joint_mvd may represent the signaled joint MVD, td0 may represent the distance between the reference frame 0 and the current frame, and td1 may represent the distance between the reference frame 1 and the current frame.

Alternatively, for example, when the JOINT_NEWMV mode is applied to the current block, the joint MVD (i.e., joint_mvd) and scaling factor information of the current block may be signaled. For example, the scaling factor information may indicate one of scaling factor pairs. A scaling factor pair indicated by the scaling factor information may be derived as a scaling factor for MVD0 and a scaling factor for MVD1 of the current block, MVD0 may be derived by multiplying the joint MVD by the scaling factor for MVD0, and MVD1 may be derived by multiplying the joint MVD by the scaling factor for MVD1.

As an example, scaling factor pair candidates may be as follows.

TABLE 3

| Index | scale factor of MVD0 | scale factor of MVD1 |
|---|---|---|
| 0 | 1 | 2 |
| 1 | 1 | 4 |
| 2 | 2 | 1 |
| 3 | 4 | 1 |
| 4 | 1 | −2 |
| 5 | 1 | −4 |
| 6 | 2 | −1 |
| 7 | 4 | −1 |

Referring to Table 3, the scaling factor pair indicated by the scaling factor information may include a scaling factor for MVD0 and a scaling factor for MVD1. For example, referring to Table 3, when a value of the scaling factor information is 0, the scaling factor for MVD0 may be derived as 1 and the scaling factor for MVD1 may be derived as 2. In addition, for example, when the value of the scaling factor information is 1, the scaling factor for MVD0 may be derived as 1 and the scaling factor for MVD1 may be derived as 4. The scaling factor pair candidates shown in the above table are merely examples and are not limited thereto.

MVD0 may be derived by multiplying the signaled joint MVD by the derived scaling factor for MVD0, and MVD1 may be derived by multiplying the joint MVD by the scaling factor for MVD1.

In addition, as described above, when inter prediction is applied to the current block, a predicted block (prediction sample array) for the current block may be derived based on a reference block (reference sample array) specified by a motion vector on a reference picture indicated by a reference picture index. Here, a reference picture list including reference pictures for the current picture may be constructed, and the reference picture index may indicate one reference picture among the reference pictures of the reference picture list. The current picture may also be referred to as the current frame, and the reference picture may also be referred to as the reference frame.

For example, when inter prediction is applied to the current block, a reference frame list including reference frames may be constructed, and a predicted block (prediction sample array) for the current block may be derived based on a reference block (reference sample array) specified by a motion vector on a reference frame indicated by a reference frame index for the current frame.

For example, seven reference frames may be used for the current frame as shown in the following table.

TABLE 4

| Name | Description |
|---|---|
| LAST_FRAME | nearest past frame |
| LAST2_FRAME | second near past frame |
| LAST3_FRAME | third near past frame |
| GOLDEN_FRAME | distant past frame |
| BWDREF_FRAME | a backward reference to the closest frame |
| ALTREF2_FRAME | the next closest backward reference |
| ALTREF_FRAME | a backward reference to the frame with |
| | highest output order |

Referring to Table 4, the reference frame list including LAST_FRAME, LAST2_FRAME, LAST3_FRAME, GOLDEN_FRAME, BWDREF_FRAME, ALTREF2_FRAME, and ALTREF_FRAME of the current frame may be constructed. As illustrated in Table 4, LAST_FRAME may represent a closest past frame, LAST2_FRAME may represent a second closest past frame, LAST3_FRAME may represent a third closest past frame, GOLDEN_FRAME may represent a distant past frame, BWDREF_FRAME may represent a backward reference for the closest frame, ALTREF2_FRAME may represent a next closest backward reference, and ALTREF_FRAME may represent a backward reference for a frame with the highest output order. For example, a reference frame index indicating the LAST_FRAME and a reference frame index indicating the GOLDEN_FRAME may be explicitly signaled. The reference frame index indicating the LAST_FRAME may be referred to as a last frame index, and the reference frame index indicating the GOLDEN_FRAME may be referred to as a gold frame index. Reference frames other than the LAST_FRAME and the GOLDEN_FRAME may be derived based on the last frame index and the gold frame index. That is, the reference frames other than the LAST_FRAME and the GOLDEN_FRAME may be derived based on the LAST_FRAME indicated by the last frame index and the GOLDEN_FRAME indicated by the gold frame index.

Meanwhile, when only the distance from the current frame is considered, a case in which similarity with the current frame changes due to a difference in quantization parameter may not be reflected. Therefore, a reference frame list may be constructed in consideration of a difference in similarity caused by the difference in quantization parameter, so that a reference frame with high similarity may be derived as a candidate with a small index, and thereby the effect of reducing the amount of bits of signaled reference frame related information may be generated.

For example, the reference frames may be replaced with rank 0 through rank 6. For example, a reference frame list for the current frame may be constructed based on a cost of a reference frame of the current frame.

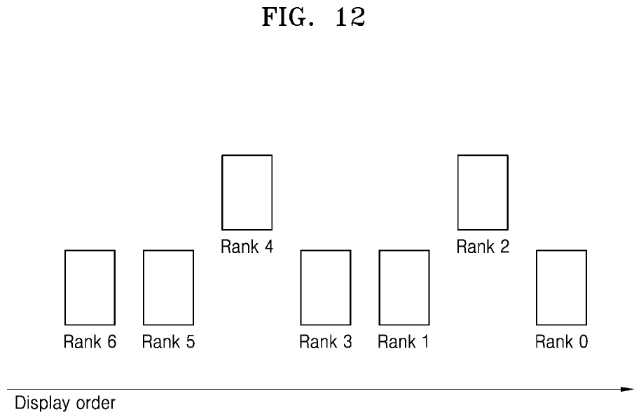

FIG. 12 illustrates an embodiment of constructing a reference frame list based on costs.

For example, the number of reference frames (num_total_refs) of the current frame and ranks of the reference frames may be implicitly derived. For example, up to seven frames may be derived as reference frames of the current frame from the LAST_FRAME, LAST2_FRAME, LAST3_FRAME, GOLDEN_FRAME, BWDREF_FRAME, ALTREF2_FRAME, and ALTREF_FRAME of the current frame, and ranks of the reference frames may be derived based on costs of the reference frames. In this case, for example, a last frame index indicating the LAST_FRAME and a gold frame index indicating the GOLDEN_FRAME may be explicitly signaled. The reference frame indicated by the last frame index may be derived as the LAST_FRAME, and the reference frame indicated by the gold frame index may be derived as the GOLDEN_FRAME, and the reference frames other than the LAST_FRAME and the GOLDEN_FRAME may be derived based on the last frame index and the gold frame index.

Alternatively, for example, costs of reference frames coded before the current frame may be derived, and up to seven reference frames from rank 0 to rank 6 may be derived based on the costs of the reference frames. For example, up to seven reference frames from rank 0 to rank 6 may be derived in ascending order of costs among the reference frames. The reference frame with the smallest cost among the reference frames may be derived as rank 0, the reference frame with the second smallest cost may be derived as rank 1, the reference frame with the third smallest cost may be derived as rank 2, the reference frame with the fourth smallest cost may be derived as rank 3, the reference frame with the fifth smallest cost may be derived as rank 4, the reference frame with the sixth smallest cost may be derived as rank 5, and the reference frame with the seventh smallest cost may be derived as rank 6.

Here, a cost of a reference frame may be derived based on 1) a temporal distance of the reference frame and 2) a quantization parameter (quantizer) of the reference frame. For example, the cost of the reference frame may be derived based on the following equation.

$$cost = 64 \cdot d + q \qquad [ Equation 7 ]$$

Here, cost represents the cost of the reference frame, d represents the temporal distance of the reference frame, and q represents the quantization parameter of the reference frame. The distance of the reference frame may be a difference between a picture order count (POC) of the current frame and a POC of the reference frame. Alternatively, the distance of the reference frame may be a difference between a display order count of the current frame and a display order count of the reference frame. The ranks of the reference frames may be derived in ascending order of cost. That is, the reference frames may be sorted in ascending order of cost.

In addition, for example, the reference frames may be derived from frames having a temporal distance equal to or less than a specific value among stored frames. The specific value may be a preset value. Alternatively, for example, the reference frames may be derived from frames having a cost equal to or less than a specific value among stored frames. The specific value may be a preset value.

Subsequently, a reference frame index for the current block may be signaled, and a reference frame of a rank indicated by the reference frame index may be derived as the reference frame of the current block.

For example, the reference frame index may be signaled as a unary codeword. For example, when a compound reference mode is applied to the current block, two reference frames of the current block may be derived based on the reference frame index.

For example, when num_total_refs of the current frame is 4 and a compound reference mode is applied to the current block based on a reference frame of rank 2 and a reference frame of rank 4, the reference frame index of the current block may be coded as 010. In addition, for example, when num_total_refs of the current frame is greater than 4 and a compound reference mode is applied to the current block based on a reference frame of rank 2 and a reference frame of rank 4, the reference frame index of the current block may be coded as 0101.

In addition, for example, the reference frame index may be signaled in a frame header, tile group, tile, or block level. The bit of the reference frame index may be a bit transmitted to indicate whether a candidate of the reference frame list is to be used.

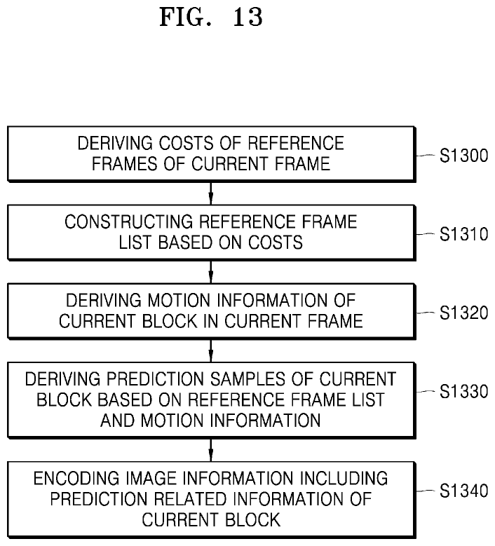

FIG. 13 schematically illustrates a video/image encoding method according to an embodiment(s) of the disclosure. The method disclosed in FIG. 13 may be performed by the encoding apparatus disclosed in FIG. 2. Specifically, for example, S1300 to S1330 of FIG. 13 may be performed by the predictor 220 of the encoding apparatus 200, and S1340 of FIG. 13 may be performed by the entropy encoder 240 of the encoding apparatus 200. The method disclosed in FIG. 13 may include the foregoing embodiments of the disclosure.

Referring to FIG. 13, the encoding apparatus derives costs of reference frames of a current frame (S1300). The encoding apparatus may derive reference frames of a current frame and may derive costs of the reference frames. For example, a cost of a reference frame of the current frame may be derived based on a temporal distance and a quantization parameter of the reference frame. For example, the cost may be derived based on Equation 7 described above.

In addition, for example, the reference frames of the current frame may be derived based on GOLDEN_FRAME and LAST_FRAME of the current frame. For example, LAST2_FRAME, LAST3_FRAME, BWDREF_FRAME, ALTREF2_FRAME, and/or ALTREF_FRAME may be derived based on the GOLDEN_FRAME and the LAST_FRAME. The costs of the derived reference frames may be derived. In addition, for example, the number of the reference frames may be implicitly derived. That is, for example, information about the number of the reference frames may not be signaled. For example, the number of the reference frames may be up to seven. In addition, for example, reference frame related information including a gold frame index indicating the GOLDEN_FRAME and a last frame index indicating the LAST_FRAME of the current frame may be generated.

Alternatively, for example, the reference frames of the current frame may be derived based on a specific reference frame of the current frame. The costs of the derived reference frames may be derived. In addition, for example, the number of the reference frames may be implicitly derived. That is, for example, information about the number of the reference frames may not be signaled. For example, the number of the reference frames may be up to seven. In addition, for example, reference frame related information including a reference frame index indicating a specific reference frame of the current frame may be generated.

Alternatively, for example, the reference frames of the current frame may be frames coded and stored before the current frame. For example, the reference frames may be derived from frames having a temporal distance equal to or less than a specific value among stored frames. The specific value may be a preset value. Alternatively, for example, the reference frames may be derived from frames having a cost equal to or less than a specific value among stored frames. The specific value may be a preset value. For example, the number of the reference frames may be implicitly derived. That is, for example, information about the number of the reference frames may not be signaled. For example, the number of the reference frames may be up to seven.

The encoding apparatus constructs a reference frame list based on the costs (S1310). The encoding apparatus may construct the reference frame list by sorting the reference frames based on the costs.

For example, ranks of the reference frames may be derived based on the costs of the reference frames, and the reference frame list may be constructed by sorting the reference frames in order of ascending rank. For example, a reference frame with the smallest cost among the reference frames may be derived as rank 0 of the reference frame list, and a reference frame with the n-th smallest cost among the reference frames may be derived as rank n−1 of the reference frame list.

The encoding apparatus derives motion information of a current block in the current frame (S1320). For example, the encoding apparatus may derive an inter prediction mode to be applied to the current block from among inter prediction modes based on RD cost, and may derive motion information of the current block based on the derived inter prediction mode. The motion information may indicate a reference block in a reference frame included in the reference frame list.

The encoding apparatus derives prediction samples of the current block based on the reference frame list and the motion information (S1330). For example, the encoding apparatus may generate prediction samples for the current block based on a reference sample in a reference frame of the current block derived based on the reference frame list and the motion information. In this case, as described above, a prediction sample filtering procedure may be further performed on all or some of the prediction samples of the current block as the case may be.

The encoding apparatus encodes image information including reference frame related information of the current frame (S1340). The encoding apparatus may generate reference frame related information of the current frame.

For example, the reference frame related information of the current frame may include a gold frame index indicating the GOLDEN_FRAME and a last frame index indicating the LAST_FRAME of the current frame. Alternatively, for example, the reference frame-related information of the current frame may include a reference frame index indicating a specific reference frame of the current frame.

In addition, for example, the encoding apparatus may generate prediction related information of the current block.

As an example, the prediction related information may include prediction mode information and/or motion type information of the current block. For example, the prediction mode information may include at least one of a newmv mode index, a zeromv mode index, a refmv mode index, or a compound mode index. The newmv mode index may indicate whether the inter prediction mode of the current block is the NEWMV mode, the zeromv mode index may indicate whether the inter prediction mode of the current block is the GLOBALMV mode, the refmv mode index may indicate whether the inter prediction mode of the current block is the NEARESTMV mode or the NEARMV mode, and the compound mode index may indicate one of compound modes as the inter prediction mode of the current block.

For example, the zeromv mode index may be signaled when a value of the newmv mode index is 1. In addition, for example, the refmv mode index may be signaled when a value of the zeromv mode index is 1.

In addition, for example, the compound mode index may be signaled when the compound reference mode is applied to the current block.

For example, the prediction related information may include at least one reference frame index of the current block. For example, the prediction related information may include a reference frame index indicating a reference frame 0 of the current block. Alternatively, for example, the prediction related information may include a reference frame index indicating a reference frame 0 of the current block and a reference frame index indicating a reference frame 1 of the current block. When the reference frame index indicating the reference frame 1 of the current block indicates NONE, the single reference mode may be applied to the current block, and when the reference frame index indicating the reference frame 1 of the current block does not indicate NONE, the compound reference mode may be applied to the current block.

In addition, for example, the prediction related information may include motion vector information of the current block. For example, when the NEWMV mode or the NEARMV mode is applied to the current block, the prediction related information may include a motion vector candidate index indicating a motion vector candidate from a motion vector candidate list. In addition, for example, when the NEWMV mode is applied to the current block, the motion vector related information may further include MVD related information.

In addition, the image information may include various information according to embodiments of the present disclosure.

Meanwhile, the image information may include residual information. The residual information is information about residual samples. The residual information may include information about quantized transform coefficients for the residual samples.

The encoded image information may be output in a form of a bitstream. The bitstream may be transmitted to the decoding apparatus through a network or a storage medium. For example, image data including the bitstream may be transmitted to the decoding apparatus by a transmitting apparatus (or a transmitter). In this case, the image data including the bitstream may be transmitted to the decoding apparatus through a streaming server.

In addition, as described above, the encoding apparatus may generate a reconstructed picture (including reconstructed samples and reconstructed blocks) based on the reference samples and the residual samples. This is because the encoding apparatus derives the same prediction result as that performed in the decoding apparatus, thereby improving coding efficiency. Therefore, the encoding apparatus may store the reconstructed picture (or reconstructed samples, reconstructed blocks) in a memory and use the reconstructed frame as a reference frame for inter prediction. As described above, an in-loop filtering procedure and so on may be further applied to the reconstructed frame.

According to the above-described embodiment(s), a reference frame list for the current frame may be constructed using costs derived based on a temporal distance and a quantization parameter of a reference frame, and through this, the amount of data for inter prediction may be reduced by using the reference frame list constructed with reference frames having high similarity in an earlier order. In addition, the reference frame list may be constructed in consideration of the quantization parameter of the reference frame, and through this, the accuracy of inter prediction may be improved based on the reference frame with high similarity.

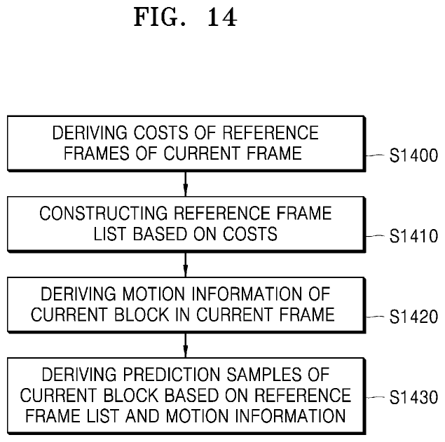

FIG. 14 schematically illustrates a video/image decoding method according to an embodiment(s) of the disclosure. The method disclosed in FIG. 14 may be performed by the decoding apparatus disclosed in FIG. 3. Specifically, for example, S1400 to S1430 of FIG. 14 may be performed by the predictor 330 of the decoding apparatus 300. The method disclosed in FIG. 14 may include the embodiments described above in the disclosure.

Referring to FIG. 14, the decoding apparatus derives costs of reference frames of a current frame (S1400). The decoding apparatus may derive reference frames of a current frame and may derive costs of the reference frames. For example, a cost of a reference frame of the current frame may be derived based on a temporal distance and a quantization parameter of the reference frame. For example, the cost may be derived based on Equation 7 described above.

In addition, for example, the reference frames of the current frame may be reference frames derived based on a gold frame index indicating GOLDEN_FRAME and a last frame index indicating LAST_FRAME of the current frame. For example, the decoding apparatus may obtain reference frame related information of the current frame, and the reference frame related information may include a gold frame index indicating the GOLDEN_FRAME and a last frame index indicating the LAST_FRAME of the current frame. The GOLDEN_FRAME may be derived based on the gold frame index, and the LAST_FRAME may be derived based on the last frame index, and LAST2_FRAME, LAST3_FRAME, BWDREF_FRAME, ALTREF2_FRAME, and/or ALTREF_FRAME may be derived based on the GOLDEN_FRAME and the LAST_FRAME. The costs of the derived reference frames may be derived. In addition, for example, the number of the reference frames may be implicitly derived. That is, for example, the number of the reference frames may be derived without separately signaled information. For example, the number of the reference frames may be up to seven.

Alternatively, for example, the reference frames of the current frame may be reference frames derived based on a reference frame index indicating a specific reference frame of the current frame. The decoding apparatus may obtain reference frame related information of the current frame, and the reference frame related information may include a reference frame index indicating a specific reference frame of the current frame. In addition, for example, the number of the reference frames may be implicitly derived. That is, for example, the number of the reference frames may be derived without separately signaled information. For example, the number of the reference frames may be up to seven.

Alternatively, for example, the reference frames of the current frame may be frames coded and stored before the current frame. For example, the reference frames may be derived from frames having a temporal distance equal to or less than a specific value among stored frames. The specific value may be a preset value. Alternatively, for example, the reference frames may be derived from frames having a cost equal to or less than a specific value among stored frames. The specific value may be a preset value. For example, the number of the reference frames may be implicitly derived. That is, for example, the number of the reference frames may be derived without separately signaled information. For example, the number of the reference frames may be up to seven.

In addition, the decoding apparatus may obtain image information including prediction related information of the current block in the current frame through a bitstream. The image information may further include residual information as described above.

As an example, the prediction related information may include prediction mode information and/or motion type information of the current block. For example, the prediction mode information may include at least one of a newmv mode index, a zeromv mode index, a refmv mode index, or a compound mode index. The newmv mode index may indicate whether the inter prediction mode of the current block is the NEWMV mode, the zeromv mode index may indicate whether the inter prediction mode of the current block is the GLOBALMV mode, the refmv mode index may indicate whether the inter prediction mode of the current block is the NEARESTMV mode or the NEARMV mode, and the compound mode index may indicate one of compound modes as the inter prediction mode of the current block.

For example, the zeromv mode index may be signaled when a value of the newmv mode index is 1. In addition, for example, the refmv mode index may be signaled when a value of the zeromv mode index is 1.

In addition, for example, the compound mode index may be signaled when the compound reference mode is applied to the current block.

For example, the prediction related information may include at least one reference frame index of the current block. For example, the prediction related information may include a reference frame index indicating a reference frame 0 of the current block. Alternatively, for example, the prediction related information may include a reference frame index indicating a reference frame 0 of the current block and a reference frame index indicating a reference frame 1 of the current block. When the reference frame index indicating the reference frame 1 of the current block indicates NONE, the single reference mode may be applied to the current block, and when the reference frame index indicating the reference frame 1 of the current block does not indicate NONE, the compound reference mode may be applied to the current block.

In addition, for example, the prediction related information may include motion vector information of the current block. For example, when the NEWMV mode or the NEARMV mode is applied to the current block, the prediction related information may include a motion vector candidate index indicating a motion vector candidate from a motion vector candidate list. In addition, for example, when the NEWMV mode is applied to the current block, the motion vector related information may further include MVD related information.

The decoding apparatus constructs a reference frame list based on the costs (S1410). The decoding apparatus may construct the reference frame list by sorting the reference frames based on the costs.

For example, ranks of the reference frames may be derived based on the costs of the reference frames, and the reference frame list may be constructed by sorting the reference frames in ascending order of rank. For example, the reference frame with the smallest cost among the reference frames may be derived as rank 0 of the reference frame list, and the reference frame with the n-th smallest cost among the reference frames may be derived as rank n−1 of the reference frame list.

The decoding apparatus derives motion information of a current block in the current frame (S1420). The decoding apparatus may derive motion information of the current block. For example, the decoding apparatus may obtain prediction related information of the current block and may derive the motion information of the current block based on the prediction related information.

For example, the prediction related information may include a reference frame index indicating a reference frame in the reference frame list. For example, when a value of the reference frame index is a specific value, a reference frame of a rank corresponding to the specific value may be derived as a reference frame of the current block.

In addition, for example, the prediction related information may include motion vector information of the current block. For example, when the NEWMV mode or the NEARMV mode is applied to the current block, the prediction related information may include a motion vector candidate index indicating a motion vector candidate from a motion vector candidate list. In addition, for example, when the NEWMV mode is applied to the current block, the motion vector related information may further include MVD related information.

For example, the decoding apparatus may derive the motion information of the current block based on the prediction related information. The motion information may indicate a reference block in a reference frame indicated by the reference frame index.

The decoding apparatus derives prediction samples of the current block based on the reference frame list and the motion information (S1430).

For example, the decoding apparatus may generate prediction samples for the current block based on a reference sample in a reference frame of the current block derived based on the reference frame list and the motion information. In this case, as described above, a prediction sample filtering procedure may be further performed on all or some of the prediction samples of the current block as the case may be.

The decoding apparatus may generate reconstructed samples based on the prediction samples of the current block. For example, the decoding apparatus may generate the reconstructed samples for the current block based on the residual samples for the current block and the prediction samples. The residual samples for the current block may be generated based on the received residual information. In addition, the decoding apparatus may, as an example, generate a reconstructed picture including the reconstructed samples. An in-loop filtering procedure and the like may be further applied to the reconstructed picture as described above.

According to the above-described embodiment(s), a reference frame list for the current frame may be constructed using costs derived based on a temporal distance and a quantization parameter of a reference frame, and through this, the amount of data for inter prediction may be reduced by using the reference frame list constructed with reference frames having high similarity in an earlier order. In addition, the reference frame list may be constructed in consideration of the quantization parameter of the reference frame, and through this, the accuracy of inter prediction may be improved based on the reference frame with high similarity.

Although the methods are described based on a flowchart as a series of steps or blocks in the aforementioned embodiments, the embodiments are not limited to the order of the steps, and a certain step may occur in a different order or concurrently with another step described above. Furthermore, it will be understood by those skilled in the art that the steps shown in the flowchart are not exclusive, and that other steps may be included or one or more steps in the flowchart may be deleted without affecting the scope of the embodiments of the disclosure

The aforementioned methods according to the embodiments of the disclosure may be implemented in software form, and the encoding apparatus and/or the decoding apparatus according to the disclosure may be included in a device for performing image processing, for example, a TV, a computer, a smartphone, a set-top box, and a display device.

The aforementioned embodiments of the disclosure may be implemented in the form of a recording medium including a computer-executable (program) instruction, such as a program module executed by a computer. The module may be stored in a memory and executed by a processor. The memory may reside inside or outside the processor, and may be connected to the processor by various well-known means. A computer-readable medium may be any available medium accessible by a computer, and may include both volatile and nonvolatile media and removable and non-removable media. Furthermore, the computer-readable medium may include both a computer storage medium and a communication medium. The computer storage medium may include both volatile and nonvolatile media and removable and non-removable media implemented in any method or technology for storing information, such as a computer-readable instruction, a data structure, a program module, or other data. The communication medium typically includes a computer-readable instruction, a data structure, a program module, other data in a modulated data signal such as a carrier wave, or other transfer mechanisms, and includes any information delivery medium.

Furthermore, the embodiments of the disclosure described above may be implemented as a computer program (or computer program product) including a computer-executable instruction. The computer program may include a programmable machine instruction processed by a processor, and may be implemented in a high-level programming language, an object-oriented programming language, an assembly language, or a machine language. In addition, the computer program may be recorded in a tangible computer-readable recording medium (e.g., a memory, a hard disk, a magnetic/optical medium, or a solid-state drive (SSD).

Therefore, the embodiments of the disclosure may be implemented as the aforementioned computer program is executed by a computing device. The computing device may include at least some of a processor, a memory, a storage device, a high-speed interface connected to the memory and a high-speed expansion port, and a low-speed interface connected to a low-speed bus and the storage device. These components may be interconnected via various buses, and may be mounted on a common motherboard or in other suitable manners.

The processor may process an instruction within the computing device. The instruction may include an instruction stored in the memory or the storage device to display graphical information for providing a graphical user interface (GUI) on an external input/output device, such as a display connected to the high-speed interface. In another embodiment, a plurality of processors and/or a plurality of buses may be utilized appropriately along with a plurality of memories and memory types. Further, the processor may be implemented as a chipset of chips including a plurality of independent analog and (or) digital processors.

The memory stores information within the computing device. For example, the memory may include a volatile memory unit or a set of volatile memory units. In another example, the memory may include a nonvolatile memory unit or a set of nonvolatile memory units. The memory may also be another form of computer-readable medium, such as a magnetic or optical disk.

The storage device may provide a high-capacity storage space for the computing device. The storage device may be a computer-readable medium or a component including a computer-readable medium. For example, the storage device may include devices or other components within a storage area network (SAN), and may be a floppy disk device, a hard disk device, an optical disk device, a tape device, a flash memory, other similar semiconductor memory devices, or an array of devices.

The network may be implemented as a wired network, such as a local area network (LAN), a wide area network (WAN), or a value-added network (VAN), or various types of wireless networks, such as a mobile radio communication network or a satellite communication network.

Although the disclosure has been described with reference to the embodiments illustrated in the drawings, these embodiments are merely exemplary. It will be understood by those skilled in the art that various modifications and variations of the embodiments are possible. That is, the scope of the disclosure is not limited to the above-described embodiments, and various modifications and alterations made by those skilled in the art based on the basic concepts defined in the following claims also fall within the scope of the claims. Therefore, the true technical protection scope of the disclosure should be determined by the technical spirit of the appended claims.

What is claimed is:

1. An image decoding method performed by a decoding apparatus, the image decoding method comprising:
deriving costs of reference frames of a current frame;
constructing a reference frame list based on the costs;
deriving motion information of a current block in the current frame; and
deriving prediction samples of the current block based on the reference frame list and the motion information,
wherein a cost of a reference frame of the current frame is derived based on a temporal distance and a quantization parameter of the reference frame.

2. The image decoding method of claim 1, wherein the cost is derived based on the following equation,
$$cost = 64 \cdot d + q$$
wherein d represents the temporal distance of the reference frame and q represents the quantization parameter of the reference frame.

3. The image decoding method of claim 1, further comprising: obtaining reference frame related information of the current frame,
wherein the reference frame related information includes a gold frame index indicating a GOLDEN_FRAME and a last frame index indicating a LAST_FRAME of the current frame.

4. The image decoding method of claim 3, wherein the reference frames of the current frame are reference frames derived based on the gold frame index and the last frame index.

5. The image decoding method of claim 4, wherein a number of the reference frames is up to seven.

6. The image decoding method of claim 1, wherein the reference frames of the current frame are frames coded and stored before the current frame.

7. The image decoding method of claim 6, wherein the reference frames are derived from frames having a temporal distance equal to or less than a specific value among stored frames.

8. The image decoding method of claim 6, wherein the reference frames are derived from frames having a cost equal to or less than a specific value among stored frames.

9. The image decoding method of claim 6, wherein a number of the reference frames is up to seven.

10. The image decoding method of claim 1, wherein ranks of the reference frames are derived based on the costs of the reference frames, and
the reference frame list is constructed by sorting the reference frames in ascending order of rank.

11. The image decoding method of claim 1, wherein the temporal distance of the reference frame is a difference between a picture order count (POC) of the current frame and a POC of the reference frame.

12. The image decoding method of claim 1, wherein the temporal distance of the reference frame is a difference between a display order count of the current frame and a display order count of the reference frame.

13. An image encoding method performed by an encoding apparatus, the image encoding method comprising:
deriving costs of reference frames of a current frame;
constructing a reference frame list based on the costs;
deriving motion information of a current block in the current frame;
deriving prediction samples of the current block based on the reference frame list and the motion information; and
encoding image information including reference frame related information of the current frame,
wherein a cost of a reference frame of the current frame is derived based on a temporal distance and a quantization parameter of the reference frame.

14. The image encoding method of claim 13, wherein the cost is derived based on the following equation,
$$cost = 64 \cdot d + q$$
wherein d represents the temporal distance of the reference frame and q represents the quantization parameter of the reference frame.

15. The image encoding method of claim 13, wherein the reference frames of the current frame are derived based on a GOLDEN_FRAME and a LAST_FRAME of the current frame.

16. The image encoding method of claim 15, wherein the reference frame related information includes a gold frame index indicating the GOLDEN_FRAME and a last frame index indicating the LAST_FRAME of the current frame.

17. The image encoding method of claim 16, wherein a number of the reference frames is up to seven.

18. The image encoding method of claim 13, wherein the reference frames of the current frame are frames coded and stored before the current frame.

19. The image encoding method of claim 18, wherein the reference frames are derived from frames having a cost equal to or less than a specific value among stored frames.

20. A transmission method for image data, comprising:
obtaining a bitstream generated by an image encoding method, wherein the image encoding method comprises deriving costs of reference frames of a current frame, constructing a reference frame list based on the costs, deriving motion information of a current block in the current frame, deriving prediction samples of the current block based on the reference frame list and the motion information, and encoding image information including reference frame related information of the current frame; and
transmitting image data including the bitstream,
wherein a cost of a reference frame of the current frame is derived based on a temporal distance and a quantization parameter of the reference frame.
